(19) United States
(12) Patent Application Publication
(10) Pub. No.: US 2003/0142592 A1
(43) Pub. Date: Jul. 31, 2003

(54) Magneto-optical disk apparatus capable of reproducing while enlarging magnetic domains using dc magnetic field, reproducing method, and recording/reproducing method

(76) Inventors: Kenichiro Mitani, Osaka (JP); Naoyuki Takagi, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/296,250

(22) PCT Filed: Jun. 1, 2001
(86) PCT No.: PCT/JP01/04682

(30) Foreign Application Priority Data
Jun. 9, 2000 (JP) 2000173371

(51) Int. Cl. G11B 11/00

(52) U.S. Cl. 369/13.14

(57) ABSTRACT

An magneto-optical disk device (100) includes a magnetic head (11), a DC magnetic field applying device (12), an optical head (13) and a magnetic field control circuit (16). The DC magnetic field applying device (12) applies a DC magnetic field to a magneto-optical recording medium (10) through a core of the magnetic head (11). The magnetic field control circuit (16) applies the DC magnetic field of a variable intensity to the magneto-optical recording medium (10) to determine the appropriate intensity of the DC magnetic field providing an error rate not exceeding a predetermined reference value in a reproduced signal of a predetermined recording pattern detected by the optical head (13). Consequently, the signal can be accurately reproduced from the magneto-optical recording medium (10) by domain-enlarging reproduction using the DC magnetic field.

### TECHNICAL FIELD

The present invention relates to a magneto-optical disk device for recording and/or reproducing signals on a magneto-optical recording medium, a reproduction method and a record/reproduction method.

### BACKGROUND ART

Magneto-optical recording mediums have been practical used as mediums having high densities and high reliability, and it is now expected that these mediums can be used as memories of computers and others.

In particular, a magneto-optical recording medium having a diameter of 12 cm and a storage capacity of 6 gigabytes has been developed in accordance with ASMO (Advanced Storaged Magneto Optical disk) standards, and applications thereof are being studied. The magneto-optical recording medium according to the ASMO standards has a record layer and a reproduction layer. When a laser beam is emitted thereto, a detection window at a predetermined temperature or higher is formed on the reproduction layer, and a magnetic domain on the record layer is transferred to the detection window on the reproduction layer by magnetostatic coupling so that a signal is reproduced from the magneto-optical recording medium.

Such a magneto-optical recording medium of the domain-enlarging reproduction type is also developed that a domain on a record layer is enlarged and transferred to a reproduction layer by applying an alternating magnetic field to the magneto-optical recording medium, and thereby a signal is reproduced. This magneto-optical recording medium has a record capacity of 14 gigabytes if it is 12 cm in diameter.

Recently, further research and development have been made to provide another magneto-optical recording medium, in which a signal is reproduced by enlarging and transferring a domain on a record layer to a reproduction layer by applying a DC magnetic field to the magneto-optical recording medium. Referring to FIGS. 38A, 38B and 39, description will now be given on principles of domain-enlarging reproduction for reproducing a signal by applying a DC magnetic field. Referring to FIG. 38A, when a laser beam LB is emitted onto a reproduction layer 81 of a magneto-optical recording medium 80, low-temperature regions 810 and 811, which are formed in reproduction layer and are at a lower temperature than a compensation temperature of 150° C., is magnetized such that magnetization owing to rare-earth metal is more dominant than magnetization indicated at 814 and 816 owing to transition metal because these regions 810 and 811 are rich in rare earth. As a result, low-temperature regions 810 and 811 have magnetization 813 and 815 in a direction opposite to that of magnetization 814 and 816 owing to transition metal. Since a high-temperature region 812 at or higher than the compensation temperature of 150° C. is rich in transition metal rather than rare-earth metal, magnetization 817 owing to the transition metal is dominantly performed rather than magnetization owing to the rare-earth metal. As a result, high-temperature region 812 has magnetization 818 in the same direction as magnetization 817 owing to the transition metal (see FIG. 38A). In this case, a DC magnetic field is not applied to magneto-optical recording medium 80.

Referring to FIG. 39, low-temperature regions 810 and 811 at or lower than the compensation temperature of 150° C. in reproduction layer 81 shown in FIG. 38A have a coercivity, which increases infinitely at boundaries with respect to high-temperature region 812, then decreases steeply with a distance from these boundaries, and then decreases slowly with the distance. High-temperature region 812 at or higher than the compensation temperature of 150° C. has a coercivity, which is infinite at boundaries with respect to low-temperature regions 810 and 811, decreases with a distance from these boundaries, and is minimum at the center of high-temperature region 812. A minimum value Hc2 of the coercivity in high-temperature region 812 is smaller than a minimum value Hc1 of the coercivity in low-temperature regions 810 and 811. Hc1 is in a range from 5 to 40 kA/m, and Hc2 is in a range from 2 to 40 kA/m.

Referring to FIG. 38B, when a laser beam is emitted to magneto-optical recording medium 80, high-temperature region 812 rich in transition metal is formed in reproduction layer 81. A DC magnetic field H_{DC} is externally applied. DC magnetic field H_{DC} is applied in a direction opposite to that of magnetization 818 of high-temperature region 812 rich in transition metal. A leakage magnetic field H_{L} is applied from a domain 830 at the highest temperature in record layer 83 to high-temperature region 812 in reproduction layer 81 via an intermediate layer 82. In this case, DC magnetic field H_{DC} has an intensity, which cannot invert magnetization 818 of high-temperature region 812 only by DC magnetic field H_{DC}, and thus is smaller than minimum coercivity Hc2 of high-temperature region 812 as shown in FIG. 39. Leakage magnetic field H_{L} emerging from domain 830 in record layer 83 increases with temperature, and exceeds coercivity Hc2 of high-temperature region 812 at the highest temperature if DC magnetic field H_{DC} is added thereto. Thus, a relationship of (H_{DC}+H_{L}>Hc2) is present. Thereby, high-temperature region 812 in reproduction layer 81 has the magnetization direction inverted by DC magnetic field H_{DC} and leakage magnetic field H_{L}, and therefore has magnetization 820 owing to the transition metal and entire magnetization 819 (see FIG. 38B). Magnetization 819 has the same direction as magnetization of domain 830, and high-temperature region 812 is larger than domain 830. Therefore, it can be deemed that domain 830 in record layer 83 is enlarged and transferred to high-temperature region 812 in reproduction layer 81. Domain 830 in record layer 83 is reproduced by detecting magnetization 819 in high-temperature region 812 with laser beam LB. When domain 831 having the magnetization opposite in direction to the magnetization of domain 830 is transferred to high-temperature region 812 in reproduction layer 81, the direction of leakage magnetic field H_{L} emerging from domain 831 is opposite to that in the case of domain 830 so that high-temperature region 812 is subjected to a resultant magnetic field of (H_{DC}−H_{L}) in intensity, which contains DC magnetic field H_{DC} added thereto, as shown in FIG. 39. This magnetic field is smaller than coercivity Hc2 of high-temperature region 812 (H_{DC}−H_{L}<Hc2). Therefore, magnetization 817 owing to transition metal in high-temperature region 812 and entire magnetization 818 are not inverted, and domain 831 in record layer 83 is reproduced by detecting magnetization 818 with laser beam LB.

As described above, magneto-optical recording medium 80 is subjected to DC magnetic field H_{DC} of the intensity, which cannot solely invert the magnetization of high-temperature region 812, and inversion and non-inversion of the magnetization of high-temperature region 812 are controlled in accordance with the direction of leakage magnetic field H_{L} emerging from each domain in record layer 83. Thereby, each domain in record layer 83 is enlarged and transferred to high-temperature region 812 in reproduction layer 81 for reproduction.

In the method of performing the domain-enlarging reproduction by applying the DC magnetic field, however, the intensity of the DC magnetic field may shift so that the resultant intensity of the DC magnetic field and the leakage magnetic field emerging from the record layer may become smaller than the minimum coercivity of the region rich in transition metal having a temperature raised to or above the compensation temperature. In this case, the magnetization cannot be inverted in the region rich in transition metal, and the domains in the record layer cannot be accurately transferred to the reproduction layer.

Accordingly, an object of the invention is to provide a magneto-optical disk device, a reproduction method and a record/reproduction method, which can accurately perform domain-enlarging reproduction with a DC magnetic field.

### DISCLOSURE OF THE INVENTION

A magneto-optical disk device according to the invention includes an optical head irradiating a magneto-optical recording medium including a reproduction layer being rich in rare-earth metal at a room temperature and being rich in transition metal at a compensation temperature or higher with a laser beam of an intensity raising a temperature of a portion of the reproduction layer to or above the compensation temperature, and detecting a reflected beam of the laser beam; a permanent magnet applying a DC magnetic field in the same direction as that of magnetization of the region rich in the rare-earth metal to the magneto-optical recording medium; moving means changing the intensity of the DC magnetic field applied to the magneto-optical recording medium by changing a density of magnetic flux emerging from the permanent magnet and reaching the magneto-optical recording medium; and a magnetic field control circuit changing the intensity of the DC magnetic field, thereby detecting an error rate based on a reproduced signal of a predetermined recording pattern detected by the optical head, and determining an appropriate intensity of the DC magnetic field keeping the error rate within a predetermined range.

In the magneto-optical disk device according to the invention, the permanent magnet applies the DC magnetic field to the magneto-optical recording medium. The reproduced signal is detected by changing the density of magnetic flux emerging from the permanent magnet and reaching the magneto-optical recording medium. Thereby, an error rate of the reproduced signal obtained based on the reproduced signal decreases to a minimum point with increase in intensity of the DC magnetic field applied to the magneto-optical recording medium, and then rises from the minimum point with further increase in intensity of the DC magnetic field. In this manner, the appropriate intensity of the DC magnetic field is determined to keep the error rate within the predetermined range. According to the invention, therefore, it is possible to determine the intensity of the DC magnetic field, which decreases the error rate of the reproduced signal. Consequently, the signal can be accurately reproduced by applying the DC magnetic field and enlarging the domain.

Preferably, the magneto-optical disk device further includes a magnetic head opposed to the magneto-optical recording medium, and having a core and a coil wound around the core, and the permanent magnet applies the DC magnetic field through the core.

The DC magnetic field emerging from the permanent magnet enters the core of the magnetic head opposed to the magneto-optical recording medium, and is applied to the magneto-optical recording medium with the intensity increased by the core. For changing the intensity of the DC magnetic field applied to the magneto-optical recording medium, a density of the magnetic flux applied to the core from the permanent magnet is changed. According to the invention, therefore, the DC magnetic field of the intensity required for the domain-enlarging reproduction can be applied to the magneto-optical recording medium by using the permanent magnet, which cannot solely provide the intensity required for the domain-enlarging reproduction. Further, by locating the core of the magnetic head coaxial with the laser beam, the center of the DC magnetic field can align with the optical axis of the laser beam.

Preferably, the magneto-optical disk device further includes a magnetic element having an incoming surface neighboring to an outgoing surface for the DC magnetic field of the permanent magnet, and an outgoing surface for emitting the DC magnetic field incident from the incoming surface to the core, and the moving means changes a distance between the outgoing surface and the core by moving the magnetic element in an in-plane direction of the magneto-optical recording medium.

The permanent magnet applies the DC magnetic field to the magnetic element without changing the intensity, and the magnetic element emits the DC magnetic field toward the core of the magnetic head. The core applies the DC magnetic field to the magneto-optical recording medium. For changing the intensity of the DC magnetic field, the magnetic element is moved in the in-plane direction of the magneto-optical recording medium to change the density of the magnetic flux applied from the outgoing surface of the magnetic element to the core. According to the invention, therefore, the intensity of the DC magnetic field applied to the magneto-optical recording medium can be changed without directly moving the permanent magnet. Further, the magnetic element moves in the in-plane direction of the magneto-optical recording medium. Therefore, a space required for adjustment of the intensity of the DC magnetic field can be small in the direction of the normal to the magneto-optical recording medium.

Preferably, the moving means of the magneto-optical disk device moves the permanent magnet in the direction of the normal to the magneto-optical recording medium.

The permanent magnet is arranged in the direction of the normal to the magneto-optical recording medium, and the magnetic head is arranged between the permanent magnet and the magneto-optical recording medium. The moving means changes the distance between the permanent magnet and the core to change the density of the magnetic flux applied from the permanent magnet to the core. This changes the intensity of the DC magnetic field applied to the magneto-optical recording medium. According to the invention, therefore, the DC magnetic field, which can provide a reproduced signal of a small error rate, can be applied to the magneto-optical recording medium only by moving the permanent magnet toward or away from the magneto-optical recording medium.

Preferably, the magneto-optical disk device further includes a magnetic element having an incoming surface neighboring to an outgoing surface for the DC magnetic field of the permanent magnet and an outgoing surface for emitting the DC magnetic field incident through the incoming surface to the core, a coil wound around the magnetic element, and an ammeter detecting a current flowing through the coil of the magnetic element when the magnetic element receives the magnetic field providing a variable magnetic flux density from the magnetic head. The moving means includes a first moving mechanism moving the permanent magnet, the magnetic element and the coil wound around the magnetic element in the in-plane direction of the magneto-optical recording medium, and a second moving mechanism moving the permanent magnet, the magnetic element and the coil wound around the magnetic element in the direction of the normal to the magneto-optical recording medium to change a distance between the outgoing surface and the core of the magnetic head. The magnetic field control circuit determines an appropriate position of the permanent magnet, the magnetic element and the coil wound around the magnetic element in the in-plane direction of the magneto-optical recording medium based on a current value detected by the ammeter while moving the permanent magnet, the magnetic element and the coil wound around the magnetic element in the in-plane direction.

When the magnetic field emitted from the magnetic head and having the variable magnetic flux density is applied to the magnetic element, the density of the magnetic flux crossing the coil wound around the magnetic element changes, and electromagnetic induction occurs in the coil of the magnetic head. Thereby, a potential difference occurs between the opposite ends of the coil, and a current flows through the coil. Thereby, the position of the permanent magnet and the magnetic element in the in-plane direction of the magneto-optical recording medium is determined so that the largest change may occur in the density of the magnetic flux incident from the magnetic head, and thus the center of the core of the magnetic head may coincide with the center of the magnetic element. After the adjustment of the position in the in-plane direction of the permanent magnet, the position of the permanent magnet is adjusted in the direction of the normal to the magneto-optical recording medium. According to the invention, therefore, the intensity of the DC magnetic field applied to the magneto-optical recording medium can be determined by adjusting the positions of the permanent magnet in the in-plane and normal directions of the magneto-optical recording medium.

Preferably, the first moving mechanism of the magneto-optical disk device moves the permanent magnet, the magnetic element and the coil wound around the magnetic element in radial and tangential directions of the magneto-optical recording medium, and the magnetic field control circuit determines the appropriate positions of the permanent magnet, the magnetic element and the coil wound around the magnetic element in the radial and tangential directions based on the current value detected by the ammeter.

The permanent magnet, the magnetic element and the coil are moved in the radial and tangential directions of the magneto-optical recording medium, and the appropriate positions of the permanent magnet in the radial and tangential directions are determined by using the electromagnetic induction so that the largest change may occur in the density of the magnetic flux incident from the magnetic head. Thereby, the position of the permanent magnet is adjusted in the normal direction of the magneto-optical recording medium. According to the invention, therefore, the position of the permanent magnet can be adjusted so that the DC magnetic field may be applied to a domain formed in the magneto-optical recording medium.

Preferably, the magneto-optical disk device further includes a magnetic head drive circuit for driving the magnetic head, and escape means for locating the permanent magnet in an escape position. In the signal reproduction, the magnetic head drive circuit stops the driving of the magnetic head. In the signal recording, the magnetic head drive circuit drives the magnetic head to apply an alternating magnetic field modulated with the predetermined recording pattern to the magneto-optical recording medium, and the escape means locates the permanent magnet in the position providing substantially equal two peak intensities in the alternating magnetic field.

For recording the signal on the magneto-optical recording medium, the permanent magnet moves to the escape position so that the DC magnetic field may not be applied to the magneto-optical recording medium, and the alternating magnetic field having the substantially equal two peak intensities is applied to the magneto-optical recording medium to record the signal. For reproducing the signal from the magneto-optical recording medium, the magnetic head does not produce the alternating magnetic field. According to the invention, therefore, the record of signal by the magnetic field modulation and the reproduction by the domain-enlarging can be performed without causing mutual and adverse effects between the permanent magnet and the alternating magnetic field.

Preferably, the moving means of the magneto-optical disk device moves the permanent magnet in the direction of the normal to the magneto-optical recording medium.

The DC magnetic field emerging from the permanent magnet is directly applied to the magneto-optical recording medium. The permanent magnet moves in the normal direction of the magneto-optical recording medium to determine the appropriate intensity of the DC magnetic field applied to the magneto-optical recording medium. According to the invention, therefore, the DC magnetic field of the appropriate intensity can be applied to the magneto-optical recording medium even in the manner of directly applying the DC magnetic field to the magneto-optical recording medium.

Preferably, the magneto-optical disk device further includes rotating means rotating the permanent magnet to change the polarity of the DC magnetic field, and a laser drive circuit driving semiconductor laser included in the optical head. In the signal erasing, the rotating means rotates the permanent magnet to apply the DC magnetic field in a first direction to the magneto-optical recording medium. In the signal recording, the rotating means rotates the permanent magnet to apply the DC magnetic field in a second direction opposite to the first direction to the magneto-optical recording medium, and the laser drive circuit drives the semiconductor laser based on the predetermined recording pattern.

For erasing the signal recorded on the magneto-optical recording medium, the permanent magnet applies the DC magnetic field in the first direction to the magneto-optical recording medium. For recording the signal on the magneto-optical recording medium, the permanent magnet applies the DC magnetic field in the direction opposite to that for the erasing to the magneto-optical recording medium so that the signal recording by the optical modulation is performed. For reproducing the signal from the magneto-optical recording medium, the permanent magnet directly applies the DC magnetic field to the magneto-optical recording medium. According to the invention, therefore, the domain-enlarging reproduction of the signal can be performed by applying the DC magnetic field with the appropriate intensity even in the magneto-optical disk device, which records the signal in the optical modulation manner.

Preferably, the magneto-optical disk device further includes a magnetic head drive circuit driving the magnetic head, first escape means locating the magnetic head in an escape position, and second escape means locating the permanent magnet in an escape position. In the signal reproduction, the first escape means locates the magnetic head in a position for applying the magnetic flux emerging from the permanent magnet directly to the magneto-optical recording medium. In the signal recording, the magnetic head drive circuit drives the magnetic head to apply an alternating magnetic field modulated with the predetermined recording pattern to the magneto-optical recording medium, and the second escape means locates the permanent magnet in a position providing substantially equal two peak intensities in the alternating magnetic field.

The permanent magnet is arranged in the normal direction of the magneto-optical recording medium. The magnetic head is arranged between the permanent magnet and the magneto-optical recording medium. For recording the signal on the magneto-optical recording medium, the magnetic head applies the alternating magnetic field modulated with the predetermined recording pattern to the magneto-optical recording medium, and the permanent magnet is located in the escape position not affecting the alternating magnetic field. For reproducing the signal from the magneto-optical recording medium, the magnetic head stays in the escape position, and the permanent magnet directly applies the magnetic field to the magneto-optical recording medium. According to the invention, therefore, the signal recording by the magnetic field modulation and the signal reproducing by the domain-enlarging can be performed without causing mutual and adverse effects between the permanent magnet and the alternating magnetic field.

Preferably, the magnetic field control circuit of the magneto-optical disk device includes a binarizing circuit binarizing the reproduced signal, a ROM storing the predetermined recording pattern, a comparing circuit comparing the reproduced signal sent from the binarizing circuit with the predetermined recording pattern read from the ROM to detect an error rate, and a control circuit determining the appropriate intensity of the DC magnetic field based on the error rate.

The reproduced signal is compared with the predetermined recording pattern recorded on the magneto-optical recording medium, and thereby the error rate of the reproduced signal is detected. The appropriate intensity of the DC magnetic field is determined to keep the error rate within a predetermined range. According to the invention, therefore, the appropriate intensity of the DC magnetic field can be accurately determined.

According to the invention, a reproduction method of reproducing a signal by applying a DC magnetic field to a magneto-optical recording medium includes a first step of irradiating the magneto-optical recording medium with a laser beam of an intensity raising a temperature of a portion of a reproduction layer of the magneto-optical recording medium to or above a compensation temperature; a second step of detecting the reproduced signal of the predetermined recording pattern by changing the intensity of the DC magnetic field and a third step of detecting an error rate based on the reproduced signal and determining the appropriate intensity of the DC magnetic field to keep the error rate within a predetermined range.

According to the reproduction method of the invention, the reproduction layer of the magneto-optical recording medium is partially irradiated with the laser beam of the intensity forming a region rich in transition metal. The reproduced signal of the predetermined recording pattern is detected by changing the intensity of the DC magnetic field applied to the magneto-optical recording medium. This can provide the error rate, which lowers with increase in intensity of the DC magnetic field, and starts to rise when the intensity of the DC magnetic field further increases. According to the invention, therefore, it is possible to determine the appropriate intensity of the DC magnetic field keeping the error rate of the reproduced signal within the predetermined range. Consequently, the domain-enlarging reproduction of the signal can be performed accurately.

According to the invention, a record and reproduction method of reproducing a signal by applying a DC magnetic field to a magneto-optical recording medium and recording a signal by applying an alternating magnetic field to the magneto-optical recording medium, includes a first step of recording the signal by irradiating the magneto-optical recording medium with a laser beam, and applying an alternating magnetic field modulated with a predetermined recording pattern to the magneto-optical recording medium; a second step of irradiating the magneto-optical recording medium with a laser beam of an intensity raising a temperature of a portion of a reproduction layer of the magneto-optical recording medium to or above a compensation temperature; a third step of detecting a reproduced signal of the predetermined recording pattern by changing the intensity of the DC magnetic field; and a fourth step of detecting an error rate based on the reproduced signal and determining the appropriate intensity of the DC magnetic field to keep the error rate within a predetermined range.

According to the record and reproduction method of the invention, the predetermined recording pattern is recorded on the magneto-optical recording medium in the magnetic field modulating manner, and thereafter the domain-enlarging reproduction of the predetermined recording pattern is performed by changing the intensity of the DC magnetic field. This can provide the error rate of the reproduced signal, which lowers with increase in intensity of the DC magnetic field, and starts to rise when the intensity of the DC magnetic field further increases. According to the invention, therefore, it is possible to determine the appropriate intensity of the DC magnetic field keeping the error rate of the reproduced signal within the predetermined range. Consequently, the domain-enlarging reproduction of the signal can be accurately performed.

According to the invention, a record and reproduction method in a magneto-optical disk device for reproducing a signal by applying a DC magnetic field to a magneto-optical recording medium and record a signal by applying an alternating magnetic field to the magneto-optical recording medium, the magneto-optical disk device including a permanent magnet producing the DC magnetic field, and a magnetic head producing the alternating magnetic field, includes a first step of recording the signal by irradiating the magneto-optical recording medium with a laser beam, and applying the alternating magnetic field modulated with a predetermined recording pattern to the magneto-optical recording medium; a second step of irradiating the magneto-optical recording medium with a laser beam of an intensity raising a temperature of a portion of a reproduction layer of the magneto-optical recording medium to or above a compensation temperature; a third step of detecting the reproduced signal of the predetermined recording pattern by changing the intensity of the DC magnetic field; and a fourth step of detecting an error rate based on the reproduced signal and determining the appropriate intensity of the DC magnetic field to keep the error rate within a predetermined range. In the first step, the permanent magnet is located in an escape position providing substantially equal two peak intensities in the alternating magnetic field emitted from the magnetic head.

According to the record and reproduction method of the invention, the predetermined recording pattern is recorded on the magneto-optical recording medium in the magnetic field modulating manner. During this, the permanent magnet is located in the escape position not affecting the alternating magnetic field. Thereafter, the domain-enlarging reproduction of the predetermined recording pattern is performed by changing the intensity of the DC magnetic field. This can provide the error rate of the reproduced signal, which lowers with increase in intensity of the DC magnetic field, and starts to rise when the intensity of the DC magnetic field further increases. According to the invention, therefore, the predetermined recording pattern can be accurately recorded on the magneto-optical recording medium. Based on the predetermined recording pattern thus recorded accurately, it is possible to determine accurately the appropriate intensity of the DC magnetic field keeping the error rate of the reproduced signal within the predetermined range. Consequently, the domain-enlarging reproduction of the signal can be accurately performed.

According to the record and reproduction method, it is preferable in the third step to locate the magnetic head in an escape position for directly applying magnetic flux emerging from the permanent magnet to the magneto-optical recording medium.

When the domain-enlarging reproduction of the predetermined recording pattern is to be performed after recording the predetermined recording pattern on the magneto-optical recording medium without an influence of the DC magnetic field, the magnetic head is located in the escape position allowing the direct application of the DC magnetic field to the magneto-optical recording medium. Therefore, the intensity of the DC magnetic field can be accurately determined even in the manner of performing the domain-enlarging reproduction by directly applying the DC magnetic field to the magneto-optical recording medium.

According to the invention, a record and reproduction method of reproducing a signal by applying a DC magnetic field to a magneto-optical recording medium, and recording a signal, includes a first step of recording the signal by emitting a laser beam modulated with a predetermined recording pattern, and applying the DC magnetic field; a second step of irradiating the magneto-optical recording medium with a laser beam of an intensity raising a temperature of a portion of a reproduction layer of the magneto-optical recording medium to or above a compensation temperature; a third step of detecting a reproduced signal of the predetermined recording pattern by changing the intensity of the DC magnetic field; and a fourth step of detecting an error rate based on the reproduced signal and determining the appropriate intensity of the DC magnetic field to keep the error rate within a predetermined range.

According to the record and reproduction method of the invention, the predetermined recording pattern is recorded on the magneto-optical recording medium in the optical modulating manner. The domain-enlarging reproduction of the predetermined recording pattern is performed by changing the intensity of the DC magnetic field. This can provide an error rate of the reproduced signal, which lowers with increase in intensity of the DC magnetic field, and starts to rise when the intensity of the DC magnetic field further increases. According to the invention, therefore, it is possible to determine accurately the appropriate intensity of the DC magnetic field keeping the error rate within the predetermined range, based on the reproduced signal of the predetermined recording pattern, even in the manner of recording the signal in the optical modulation manner and performing the domain-enlarging reproduction of the signal. Consequently, the domain-enlarging reproduction of the signal can be accurately performed.

### BRIEF DESCRIPTION OF THE DRAWINGS

FIG. 1 shows a sectional structure of a magneto-optical recording medium;

FIG. 2 is a plan of a laser spot on the magneto-optical recording medium;

FIG. 3A conceptually shows domains in record and reproduction layers before irradiation with a laser beam, FIG. 3B conceptually shows the domains in the record and reproduction layers after the domain in the record layer is transferred to the reproduction layer, and FIG. 3C conceptually shows the domains in the record and reproduction layers after the domain transferred to the record layer disappeared;

FIG. 4 is a cross section showing a structure of a DC magnetic field applying device according to a first embodiment of the invention;

FIG. 5 conceptually shows a positional relationship between an iron core and a magnetic head;

FIG. 6 shows changes in intensity of the DC magnetic field on the magneto-optical recording medium with respect to a distance between the iron core and the magnetic head;

FIG. 7 is a cross section showing a drive mechanism of a linear motor in FIG. 4;

FIG. 8 is a timing chart illustrating a reproduced signal and a predetermined recording pattern;

FIG. 9 is a cross section showing an arrangement of the magnetic head, DC magnetic field applying device and an optical head;

FIG. 10 is a schematic block diagram showing a magneto-optical disk device according to the first embodiment of the invention;

FIG. 11 is a schematic block diagram of a magnetic field control circuit of the magneto-optical disk device shown in FIG. 10;

FIG. 12 is a flowchart illustrating a recording operation in the first embodiment;

FIG. 13 is a flowchart illustrating calibration of the intensity of the DC magnetic field in the first embodiment of the invention;

FIG. 14 illustrates a relationship between an error rate of the reproduced signal and the intensity of the DC magnetic field;

FIG. 15 is a flowchart illustrating a reproducing operation in the first embodiment;

FIG. 16 is a cross section showing a structure of a DC magnetic field applying device according to a second embodiment of the invention;

FIG. 17 is a flowchart illustrating calibration of an intensity of a DC magnetic field in the second embodiment;

FIG. 18 is a flowchart illustrating a reproducing operation in the second embodiment;

FIG. 19 is a cross section showing a structure of a DC magnetic field applying device according to a third embodiment of the invention;

FIG. 20 is a schematic block diagram of a magneto-optical disk device according to a third embodiment of the invention;

FIG. 21 is a schematic block diagram of a magnetic field control circuit of the magneto-optical disk device shown in FIG. 20;

FIG. 22 is a flowchart illustrating calibration of an intensity of a DC magnetic field in the third embodiment;

FIG. 23 is a flowchart illustrating a reproducing operation in the third embodiment;

FIG. 24 is a cross section showing a structure of a DC magnetic field applying device according to a fourth embodiment of the invention;

FIG. 25 is a flowchart illustrating calibration of an intensity of a DC magnetic field in the fourth embodiment;

FIG. 26 is a flowchart illustrating a reproducing operation in the fourth embodiment;

FIG. 27 is a cross section showing a structure of a DC magnetic field applying device according to a fifth embodiment of the invention;

FIG. 28 shows changes in intensity of the DC magnetic field on the magneto-optical recording medium with respect to a distance between a permanent magnet and the magneto-optical recording medium;

FIG. 29 is a schematic block diagram of a magneto-optical disk device according to the fifth embodiment;

FIG. 30 is a schematic block diagram of a magnetic field control circuit of the magneto-optical disk device shown in FIG. 29;

FIG. 31 is a flowchart of a recording operation in the fifth embodiment;

FIG. 32 is a flowchart of a reproducing operation in the fifth embodiment;

FIG. 33 is a schematic block diagram of a DC magnetic field applying device in a sixth embodiment;

FIG. 34 is a schematic block diagram of a magneto-optical disk device according to the sixth embodiment;

FIG. 35 is a schematic block diagram of a magnetic field control circuit of the magneto-optical disk device shown in FIG. 34;

FIG. 36 is a flowchart illustrating a recording operation in the sixth embodiment;

FIG. 37 is a flowchart illustrating a reproducing operation in the sixth embodiment;

FIG. 38A conceptually shows domains in record and reproduction layers before the domain in the record layer is transferred to the reproduction layer, and FIG. 38B conceptually shows the domains in the record and reproduction layers after the domain in the record layer is transferred to the reproduction layer; and

FIG. 39 illustrates distributions of coercivity in a region rich in rare-earth metal and a region rich in transition metal.

### BEST MODES FOR CARRYING OUT THE INVENTION

Embodiments of the invention will now be described in greater detail with reference to the drawings. In the figure, the same or corresponding portions bear the same reference numbers, and description thereof is not repeated.

[First Embodiment]

Referring to FIG. 1, description will now be given on a sectional structure of a magneto-optical recording medium, to and/or from which a magneto-optical disk device according to the invention records and/or reproduces signals. A magneto-optical recording medium 10 includes a transparent substrate 1, a base layer 2, a reproduction layer 3, an intermediate layer 4, a record layer 5, a protection layer 6 and ultraviolet-curing resin 7. Transparent substrate 1 is made of glass, polycarbonate or the like. Base layer 2 is made of silicon nitride (SiN). Reproduction layer 3 is made of GdFeCo containing 27-33 at. % of Gd. This GdFeCo has a compensation temperature in a range from 100 to 180° C., and forms a vertically magnetizable film at a room temperature. Intermediate layer 4 is made of SiN. Record layer 5 is made of TbFeCo. Protective layer 6 is made of SiN. SiN forming base, intermediate and protective layers 2, 4 and 6, GdFeCo forming reproduction layer 3 and TbFeCo forming record layer 5 are provided by a magnetron sputtering method. A content of Gd in GdFeCo forming reproduction layer 3 is primarily controlled by a power applied to a Gd target or a FeCo target. As the content of Gd decreases, the compensation temperature lowers. As the content of Gd increases, the compensation temperature rises.

The respective layers have the following thicknesses. Base layer 2 is 60 nm (allowed range: 40-80 nm), reproduction layer 3 is 40 nm (allowed range: 20-60 nm), and intermediate layer 4 is 20 nm (allowed range: 5-30 nm). Record layer 5 is 60 nm (allowed range: 30-1000 nm), protective layer 6 is 50 nm (allowed range: 30-70), and ultraviolet-curing resin is 3 μm (allowed range: 1-10 μm).

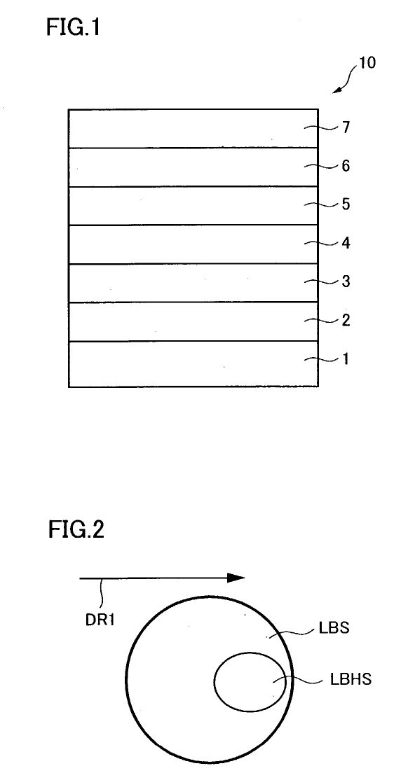

Referring to FIG. 2, when a laser beam is emitted to magneto-optical recording medium 10, a laser spot LBS is formed on magneto-optical recording medium 10. Within laser spot LBS, a high-temperature region LBHS is formed in a forward position with respect to a moving or traveling direction DR1 of magneto-optical recording medium 10. Reproduction of a signal from magneto-optical recording medium 10 is performed by transferring a domain in record layer 5 to high-temperature region LBHS in reproduction layer 3 by magnetostatic coupling, and detecting the transferred domain with the laser beam. In this operation, magneto-optical recording medium 10 is subjected to a DC magnetic field in a uniform direction so that the domain in record layer 5 is transferred in an enlarged form to high-temperature region LBHS in reproduction layer 3.

DC magnetic field H_{DC} applied to magneto-optical recording medium 10 has an intensity ranging from 6 to 56 kA/m, and the laser beam emitted to magneto-optical recording medium 10 has an intensity ranging from 2.0 to 3.5 mW. Assuming that the laser beam emitted to magneto-optical recording medium 10 has a wavelength of 635 nm and an objective lens focusing the laser beam has a numerical aperture of 0.6, laser beam spot LBS on magneto-optical recording medium 10 has a diameter of about 0.9 μm, and high-temperature region LBHS has a length from 0.2 to 0.5 μm in direction DR1. The length of high-temperature region LBHS in direction DR1 is controlled by the intensity of the laser beam emitted to magneto-optical recording medium 10. Record layer 5 has a minimum domain having a domain length of 0.1-0.2 μm. Therefore, each domain in record layer 5 can be independently enlarged and transferred to reproduction layer 3 by controlling the length of high-temperature region LBHS in direction DR1. According to the invention, therefore, the length of high-temperature region LBHS in direction DR1 is determined based on the minimum domain length formed in record layer 5. Thus, the intensity of the laser beam emitted to magneto-optical recording medium 10 is determined based on the minimum domain length of record layer 5.

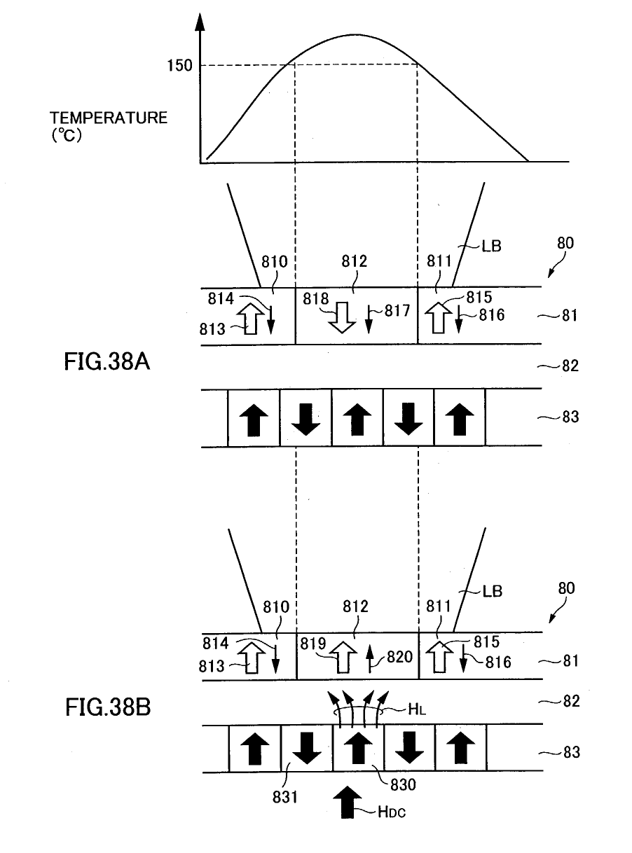

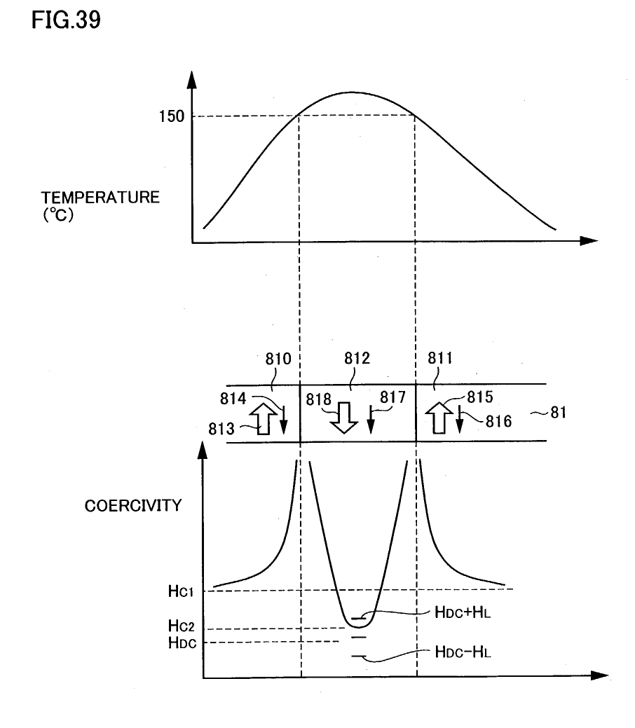

Principles of reproducing signals from magneto-optical recording medium 10 by the domain enlarging manner are the same as those already described with reference to FIGS. 38A, 38B and 39.

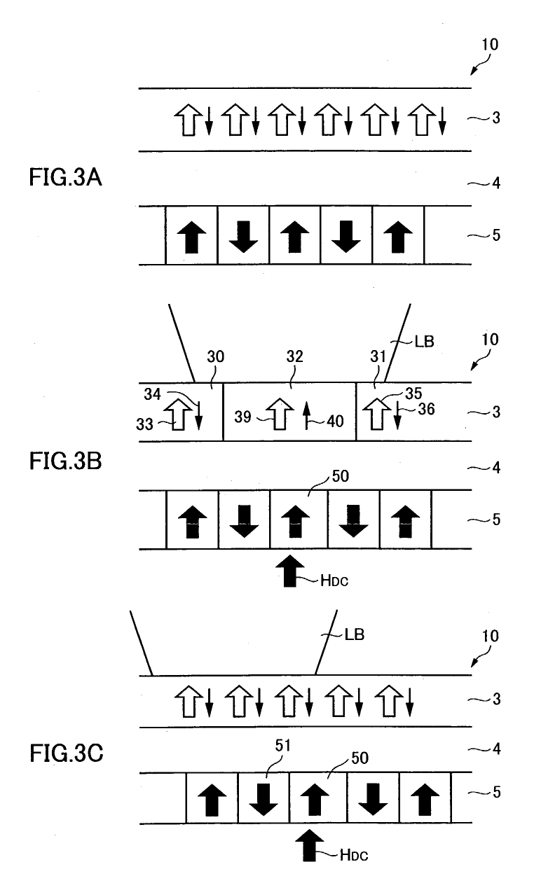

Referring to FIGS. 3A, 3B and 3C, a process of reproducing signals from magneto-optical recording medium 10 will now be described. Before start of the signal reproduction from magneto-optical recording medium 10, reproduction layer 3 is initialized to have a uniform magnetization direction, and record layer 5 is provided with domains magnetized in different directions by the record signal (see FIG. 3A). Laser beam LB is emitted toward reproduction layer 3 to apply DC magnetic field H_{DC}. Thereby, a domain 50 in record layer 5 is enlarged and transferred to a high-temperature region 32 in reproduction layer 3, and magnetization 39 is detected with laser beam LB so that a domain 50 is reproduced (see FIG. 3B). After magnetization 39 is detected, laser beam LB moves so that the temperature of high-temperature region 32 lowers to or below the compensation temperature of 150° C., and high-temperature region 32 changes from a state rich in transition metal to a state rich in rare-earth metal. Therefore, the magnetization of reproduction layer 3 returns to the initial state (FIG. 3A), in which the initializing magnetization direction is kept (see FIG. 3C). In an operation of reproducing a domain 51 magnetized in the direction opposite to domain 50, domain 51 is reproduced without inverting the magnetization of high-temperature region 32 in reproduction layer 3. Thus, domain 51 is reproduced by detecting the magnetization in the same direction as that of domain 51, i.e., by detecting the magnetization in the direction opposite to magnetization 39 of high-temperature region 32 with laser beam LB. Through the steps in FIGS. 3A-3C, each of the domains in record layer 5 is enlarged and transferred to reproduction layer 3 by the magnetostatic coupling so that the reproduction is performed.

According to the invention, a signal “01010101010 . . . ” is reproduced from magneto-optical recording medium 10 on which a predetermined recording pattern “01010101010 . . . ” is recorded, and is compared with the predetermined recording pattern “01010101010 . . . ”, and the intensity of the DC magnetic field is determined so that the error rate of the reproduced signal may fall within a predetermined range.

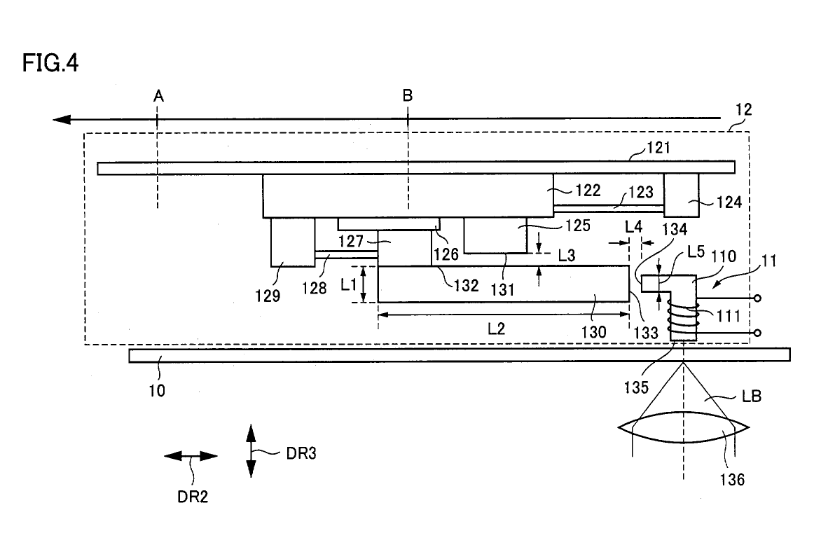

Referring to FIG. 4, description will now be given on a DC magnetic field applying device 12 according to the first embodiment of the invention. DC magnetic field applying device 12 includes rails 121 and 126, stages 122 and 127, arms 123 and 128, rough-motion linear motor 124, a permanent magnet 125, fine-motion linear motor 129, an iron core 130 and a core 110. A coil 111 is wound around core 110 to form a magnetic head 11. As will be described later, DC magnetic field H_{DC} emerging from permanent magnet 125 is applied to magneto-optical recording medium 10 through core 110 of magnetic head 11 in the signal reproducing operation. Therefore, core 110 of magnetic head 11 forms one of components of DC magnetic field applying device 12.

Stage 122 is connected to rail 121, and is movable on rail 121 in a radial direction DR2 of magneto-optical recording medium 10. Rough-motion linear motor 124 is connected to stage 122 via arm 123 so that stage 122 is moved in radial direction DR2 of magneto-optical recording medium 10 along rail 121 by expanding or contracting arm 123.

Stage 122 is provided with permanent magnet 125, rail 126 and fine-motion linear motor 129. Stage 127 is connected to rail 126, and is movable on rail 126 in radial direction DR2 of magneto-optical recording medium 10. Fine-motion linear motor 129 is connected to stage 127 via arm 128. Iron core 130 is arranged on a main surface of stage 127. Fine-motion linear motor 129 expands or contracts arm 128 to move stage 127 along rail 126 in radial direction DR1 of magneto-optical recording medium 10. Iron core 130 has an incoming surface 132 for the incident DC magnetic field, which is opposed to an outgoing surface 131 for the outgoing DC magnetic field of permanent magnet 125. Iron core 130 has an outgoing surface 133 for the outgoing DC magnetic field. Outgoing surface 133 is opposed to an incoming surface 134 for the incident DC magnetic field of core 110.

Iron core 130 has a length L1 of 1 mm in a normal direction DR3, i.e., a direction of a normal to magneto-optical recording medium 10, and a length L2 from 11.5 to 13.5 mm in radial direction DR2. A distance between outgoing surface 131 of permanent magnet 125 and incoming surface 132 of iron core 130 is in a range from 50 to 100 μm, and a distance L4 between outgoing surface 133 of iron core 130 and incoming surface 134 of core 110 is in a range from 0.1 to 2 mm. A length L5 of core 110 in normal direction DR3 is equal to 200 μm. Therefore, DC magnetic field H_{DC} emitted from permanent magnet 125 enters iron core 130 through incoming surface 132, and emerges from outgoing surface 133 of iron core 130 without reducing its intensity. The intensity of DC magnetic field H_{DC} emerging from outgoing surface 133 depends on the magnetic flux incident to incoming surface 134 of core 110, and changes in accordance with a value of distance L4. If distance L4 takes the largest value of 2 mm, the smallest number of lines of flux are applied to incoming surface 134 of core 110. If distance L4 takes the smallest value of 0.1 mm, the largest number of lines of flux are applied to incoming surface 134 of core 110. Consequently, in accordance with change in distance L4 between 0.1 mm and 2 mm, the intensity of DC magnetic field H_{DC} incident to core 110 changes. DC magnetic field H_{DC} emerges from an outgoing surface 135 of core 110, and is applied to magneto-optical recording medium 10.

Thus, DC magnetic field H_{DC} emerging from permanent magnet 125 is applied to magneto-optical recording medium 10 via iron core 130 and core 110. Fine-motion linear motor 129 moves iron core 130 in radial direction DR2 of magneto-optical recording medium 10 to change distance L4 between outgoing surface 133 of iron core 130 and incoming surface 134 of core 110 so that intensity of DC magnetic field H_{DC} applied from core 110 to magneto-optical recording medium 10 changes.

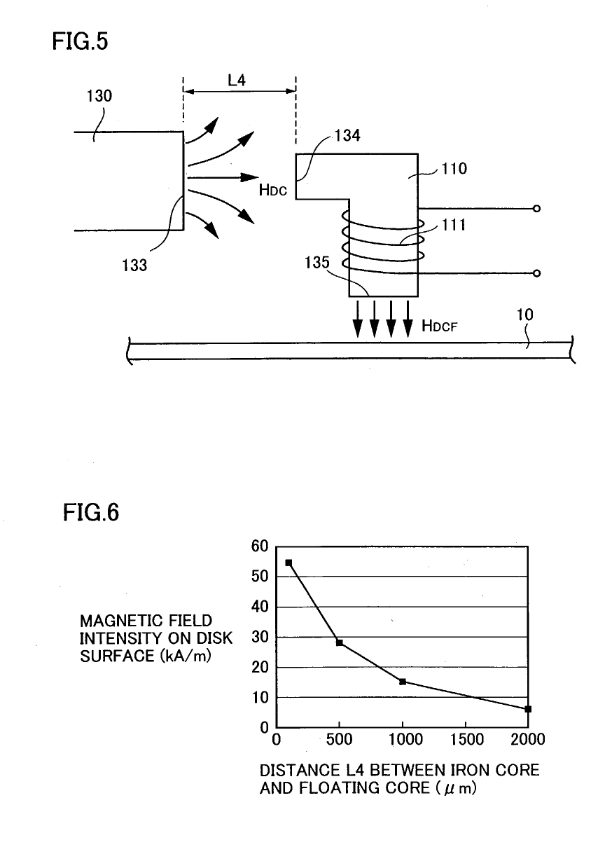

More specifically, as shown in FIG. 5, DC magnetic field H_{DC} emitted from outgoing surface 133 of iron core 130 enters core 110 through incoming surface 134, and emerges from outgoing surface 135 as DC magnetic field H_{DCF} after its intensity is increased two or three times by core 110. Since the distance between outgoing surface 135 and magneto-optical recording medium 10 is nearly equal to 10 μm, DC magnetic field H_{DCF} is applied to magneto-optical recording medium 10 without reducing its intensity. The intensity of DC magnetic field H_{DCF} is inversely proportional to distance L4 between outgoing surface 133 and incoming surface 134, provided that outgoing surface 133 has a larger area than incoming surface 134. Consequently, the intensity of DC magnetic field H_{DCF} applied to magneto-optical recording medium 10 changes inversely with distance L4 as shown in FIG. 6. If distance L4 increases from 0.1 mm to 2 mm (i.e., from 100 μm to 2000 μm), the intensity of DC magnetic field H_{DCF} decreases from 56 kA/m to 6 kA/m. By changing distance L4, therefore, it is possible to change the intensity of DC magnetic field H_{DCF} applied to magneto-optical recording medium 10.

Referring to FIG. 4 again, iron core 130 has length L1 of 1 mm in normal direction DR3 of magneto-optical recording medium 10, and core 110 has length L5 of about 200 μm in normal direction DR3 of core 110. Therefore, even when core 110 moves in normal direction DR3 due to surface vibrations of magneto-optical recording medium 10, the magnetic flux emitted from outgoing surface 133 enters incoming surface 134 of core 110 so that the surface vibrations of magneto-optical recording medium 10 do not change the intensity of DC magnetic field H_{DCF}. Further, an objective lens 136 of optical head 13 is opposed to core 110 of magnetic head 11 with magneto-optical recording medium 10 therebetween. Objective lens 136 focuses laser beam LB onto the record point or reproduction point of the signal. When the signal is to be recorded by magnetic head 11, which applies an alternating magnetic field modulated with the record signal to magneto-optical recording medium 10, rough-motion linear motor 124 moves the center of stage 122 from a point B to a point A. Since a distance between points A and B is 10 mm, outgoing surface 133 of iron core 130 is spaced from incoming surface 134 of core 110 by a distance of 10 mm or more so that DC magnetic field H_{DC} emerging from permanent magnet 125 does not enter core 110, and DC magnetic field H_{DCF} is not applied to magneto-optical recording medium 10. Therefore, magnetic head 11 can apply the alternating magnetic field to magneto-optical recording medium 10 without an influence of DC magnetic field H_{DCF}. For reproducing the signal from magneto-optical recording medium 10, rough-motion linear motor 124 moves the center of stage 122 from point A to point B, and DC magnetic field H_{DC} emerging from permanent magnet 125 is applied to magneto-optical recording medium 10 as DC magnetic field H_{DCF} viacore 110.

In this invention, fine-motion linear motor 129 moves stage 127 stepwise in radial direction DR2 of magneto-optical recording medium 10 for moving iron core 130 in radial direction DR2. Distance L4 between outgoing surface 133 of iron core 130 and incoming surface 134 of core 110 is changed stepwise between 0.1 mm and 2 mm, and DC magnetic field H_{DCF} is applied to magneto-optical recording medium 10 in response to respective values of distance L4 for detecting the reproduced signal of the predetermined recording pattern “01010101010 . . . ”. The error rate is detected by comparing the reproduced signal with the predetermined recording pattern “01010101010 . . . ”, and the intensity of DC magnetic field H_{DCF} is determined to provide the error rate falling within the predetermined range not exceeding 10⁻⁵.

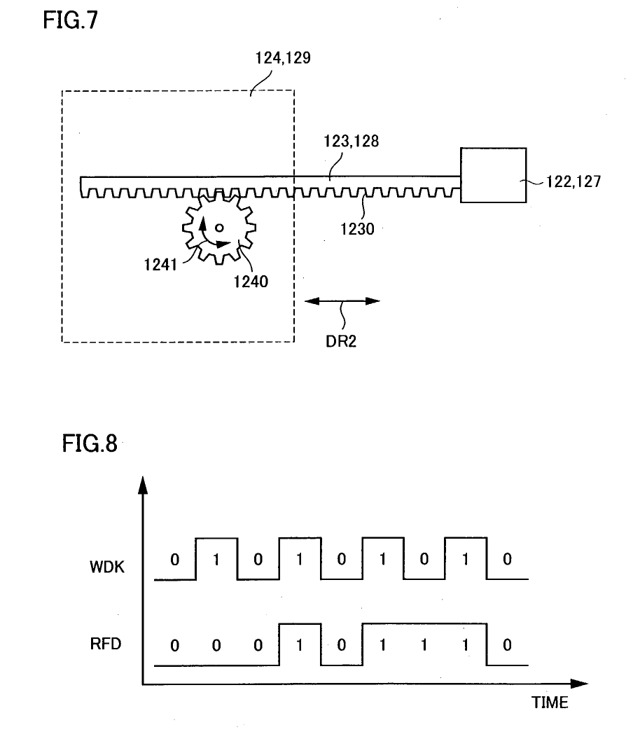

With reference to FIG. 7, description will now be given on rough-motion linear motor 124 and fine-motion linear motor 129. Each of rough-motion linear motor 124 and fine-motion linear motor 129 has a gear 1240 engaged with a gear 1230 formed on arm 123 or 128. Each of rough-motion linear motor 124 and fine-motion linear motor 129 (not shown in FIG. 7) drives stepwise to rotate gear 1240 stepwise in a direction of an arrow 1241 SO that arm 123 or 128 is moved stepwise in radial direction DR2 of magneto-optical recording medium 10. Thereby, stage 122 connected to arm 123 and state 127 connected to arm 128 move in radial direction DR2 along rails 121 and 126, respectively. By one step motion, rough-motion linear motor 124 moves stage 122 a distance longer than that of movement of stage 127 caused by fine-motion linear motor 129. The distance of movement caused by one step motion of rough-motion linear motor 124 is approximately equal to 160 μm, and the distance of movement caused by one step motion of fine-motion linear motor 129 is equal to 10 μm.

Fine-motion linear motor 129 successively or sequentially moves iron core 130 in radial direction DR2 of magneto-optical recording medium 10 such that distance L4 may successively take the values of 2000 μm, 1000 μm, 500 μm, 100 μm, 1500 μm, 750 μm, 400 μm, 300 μm and 200 μm in this order. In this case, the intensity of DC magnetic field H_{DCF} successively takes the values of 6 kA/m, 16 kA/m, 28 kA/m, 56 kA/m, 12 kA/m, 20 kA/m, 40 kA/m, 44 kA/m and 48 kA/m in this order.

TABLE 1

| Number of | Iron Core Position | Disk Surface Magnetic Field |
|---|---|---|
| Trials | (μm) | (kA/m) |
| 0 | 2000 | 6 |
| 1 | 1000 | 16 |
| 2 | 500 | 28 |
| 3 | 100 | 56 |
| 4 | 1500 | 12 |
| 5 | 750 | 20 |
| 6 | 400 | 40 |
| 7 | 300 | 44 |
| 8 | 200 | 48 |

DC magnetic field H_{DCF} having the variable intensity is applied to magneto-optical recording medium 10 to reproduce the predetermined recording pattern “01010101010 . . . ” by enlarging the domain. The reproduced signal is binarized, and is compared with the predetermined recording pattern to detect the error rate of the reproduced signal. Thus, a binarized reproduced signal RFD is compared with a predetermined recording pattern WDK to detect the error rate as shown in FIG. 8. Predetermined recording pattern WDK is “010101010”, and differs from reproduced signal RFD of “000101110” so that an error is present in two bits. Since two erroneous bits are present in nine bits, the error rate is equal to 0.22. In practice, the error is detected from the predetermined recording pattern “010101010 . . . ” by reproducing large data of about tens of thousands of bits so that the error rate is in the order of 10⁻⁵ or lower.

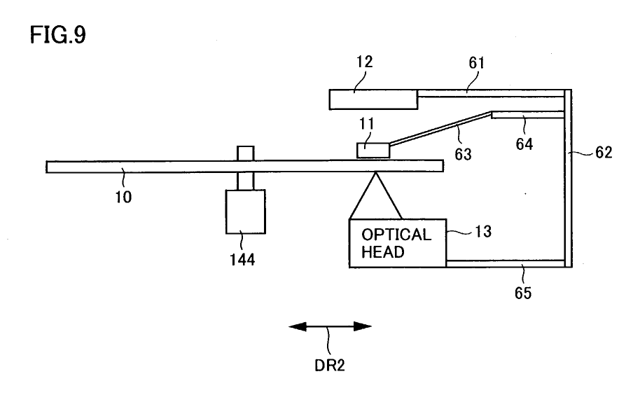

Referring to FIG. 9, for recording and/or reproducing the signal on and/or from magneto-optical recording medium 10, magnetic head 11, DC magnetic field applying device 12 and optical head 13 are used. DC magnetic field applying device 12 applies DC magnetic field H_{DCF} in the uniform direction to magneto-optical recording medium 10. Magnetic head 11 applies to magneto-optical recording medium 10 an alternating magnetic field, which has alternating directions and is modulated with a record signal. Optical head 13 emits a laser beam to magneto-optical recording medium 10, and detects a reflected beam. DC magnetic field applying device 12 is connected to a support member 62 via an arm 61.

Magnetic head 11 is of a floating type, and can float above magneto-optical recording medium 10 when a spindle motor 144 rotates magneto-optical recording medium 10. Magnetic head 11 is connected to an arm 64 by a plate spring 63. Arm 64 is connected to support member 62. Since magnetic head 11 is of the floating type, plate spring 63 pushes magnetic head 11 against magneto-optical recording medium 10. Thereby, a balance is kept between a floating force, which occurs in magnetic head 11 in accordance with the rotation of magneto-optical recording medium 10, and the pushing force applied by plate spring 63 to push magnetic head 11 against magneto-optical recording medium 10 so that a uniform distance is held between magnetic head 11 and magneto-optical recording medium 10.

Optical head 13 is connected to support member 62 via arm 65. Thus, magnetic head 11, DC magnetic field applying device 12 and optical head 13 are connected to support member 62. Therefore, when optical head 13 seeks in radial direction DR2 of magneto-optical recording medium 10, magnetic head 11 and DC magnetic field applying device 12 likewise seek in radial direction DR2. Consequently, after an adjustment is once performed to locate the center of core 110 of magnetic head 11 on the optical axis of the laser beam emitted from optical head 13, the center of DC magnetic field H_{DCF} and the center of the alternating magnetic field will not shift from the optical axis of the laser beam even when optical head 13 seeks in radial direction DR2.

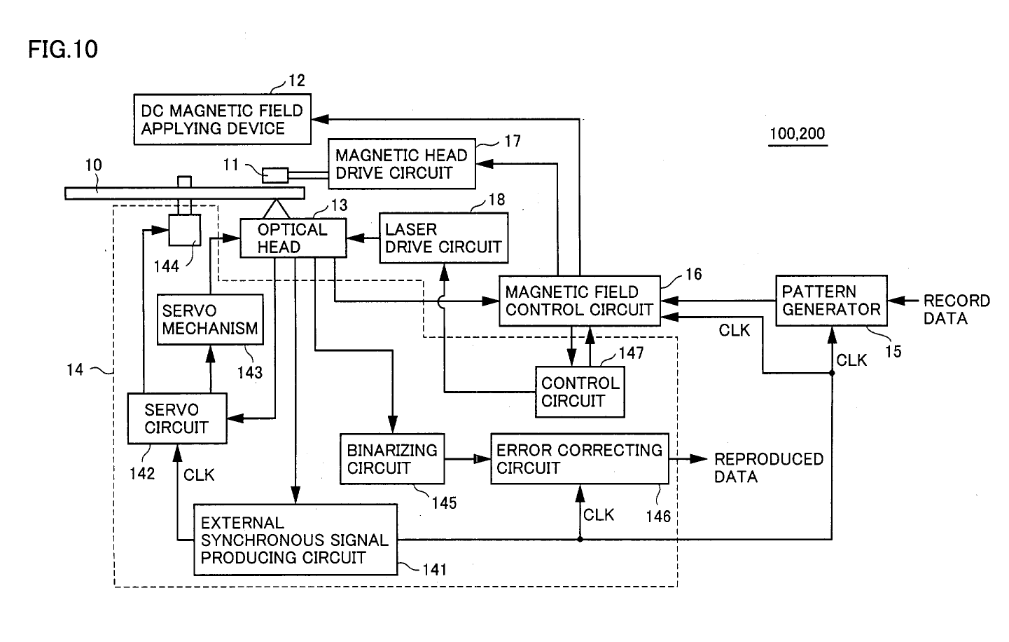

Referring to FIG. 10, magneto-optical disk device 100 according to the first embodiment of the invention includes magnetic head 11, DC magnetic field applying device 12, optical head 13, a signal processing control circuit 14, a pattern generator 15, a magnetic field control circuit 16, a magnetic head drive circuit 17 and a laser drive circuit 18.

Signal processing control circuit 14 is formed of an external synchronous signal producing circuit 141, a servo circuit 142, a servo mechanism 143, a spindle motor 144, a binarizing circuit 145, an error correcting circuit 146 and a control circuit 147.

Magnetic head 11 applies the alternating magnetic field modulated with the record signal to magneto-optical recording medium 10. DC magnetic field applying device 12 applies DC magnetic field H_{DCF} to magneto-optical recording medium 10 in the foregoing method. Optical head 13 emits the laser beam to magneto-optical recording medium 10, and detects the reflected beam. Optical head 13 amplifies detected tracking error signal TE, focus error signal FE, fine clock mark signal FCM, address signal ADD and magneto-optical signal RFA to predetermined levels, and sends tracking error signal TE and focus error signal FE to servo circuit 142. Also, optical head 13 sends fine clock mark signal FCM to external synchronous signal producing circuit 141, sends address signal ADD to magnetic field control circuit 16 and sends magneto-optical signal RFA to magnetic field control circuit 16 and binarizing circuit 145.

External synchronous signal producing circuit 141 produces an external synchronous signal CLK based on fine clock mark signal FCM. Fine clock mark signal FCM is produced by optical head 13, and particularly by detecting wobbles, which are formed at predetermined intervals on grooves and lands of magneto-optical recording medium 10, in a radial push-pull manner. Accordingly, fine clock mark signal FCM has an intensity varying at predetermined intervals. External synchronous signal producing circuit 141 produces a binary signal, which contains a pulse component changing from L-level (logical low level) to H-level (logical high level) at predetermined intervals, from fine clock mark signal FCM varying at predetermined intervals, and also produces external synchronous signal CLK such that a predetermined number of interval signals may be present between neighboring pulses of the binary signal thus produced. External synchronous signal producing circuit 141 sends external synchronous signal CLK thus produced to servo circuit 142, error correcting circuit 146 and pattern generator 15.

Servo circuit 142 controls servo mechanism 143 based on tracking error signal TE and focus error signal FE sent from optical head 13 so that servo mechanism 143 may perform the tracking servo and focus servo of objective lens 136 in optical head 13. Further, servo circuit 142 drives spindle motor 144 at a predetermined rotation speed in synchronization with external synchronous signal CLK.

Servo mechanism 143 performs tracking servo and focus servo of objective lens 136 in optical head 13 under the control of servo circuit 142. Spindle motor 144 drives magneto-optical recording medium 10 at a predetermined rotation speed under the control of servo circuit 142.

Binarizing circuit 145 performs the comparison of magneto-optical signal RFA, and produces binary reproduced signal RFD varying between H- and L-levels. Error correcting circuit 146 performs the error correction and demodulation of binary reproduced signal RFD in synchronization with external synchronous signal CLK, and outputs the reproduced data to an external output device (not shown). Control circuit 147 sends the intensity of the laser beam emitted from optical head 13 to laser drive circuit 18, and controls various portions in a magneto-optical disk device 100.

Pattern generator 15 encodes and modulates the record data into a predetermined form in synchronization with external synchronous signal CLK. When comparing the intensity of DC magnetic field H_{DCF}, magnetic field control circuit 16 sends a drive signal for driving rough-motion linear motor 124 and fine-motion linear motor 129 in DC magnetic field applying device 12 to DC magnetic field applying device 12 SO that the center of stage 122 is moved to point B, and stage 127 is moved in radial direction DR2 of magneto-optical recording medium 10. Thereby, the intensity of DC magnetic field H_{DCF} applied to magneto-optical recording medium 10 changes. Magnetic field control circuit 16 changes the intensity of DC magnetic field H_{DCF} to binarize magneto-optical signal RFA detected by optical head 13, and compares reproduced signal RFD thus binarized with the predetermined recording pattern “01010101010 . . . ” in synchronization with external synchronous signal CLK to detect the error rate of reproduced signal RFD. Further, magnetic field control circuit 16 determines the appropriate intensity of DC magnetic field H_{DCF} providing the error rate not exceeding 10⁻⁵. Further, magnetic field control circuit 16 outputs the record signal sent from pattern generator 15 to magnetic head drive circuit 17 when recording the record data on magneto-optical recording medium 10.

Magnetic head drive circuit 17 drives magnetic head 11 based on the record signal. Laser drive circuit 18 drives semiconductor laser (not shown) in optical head 13 based on the intensity sent from control circuit 147.

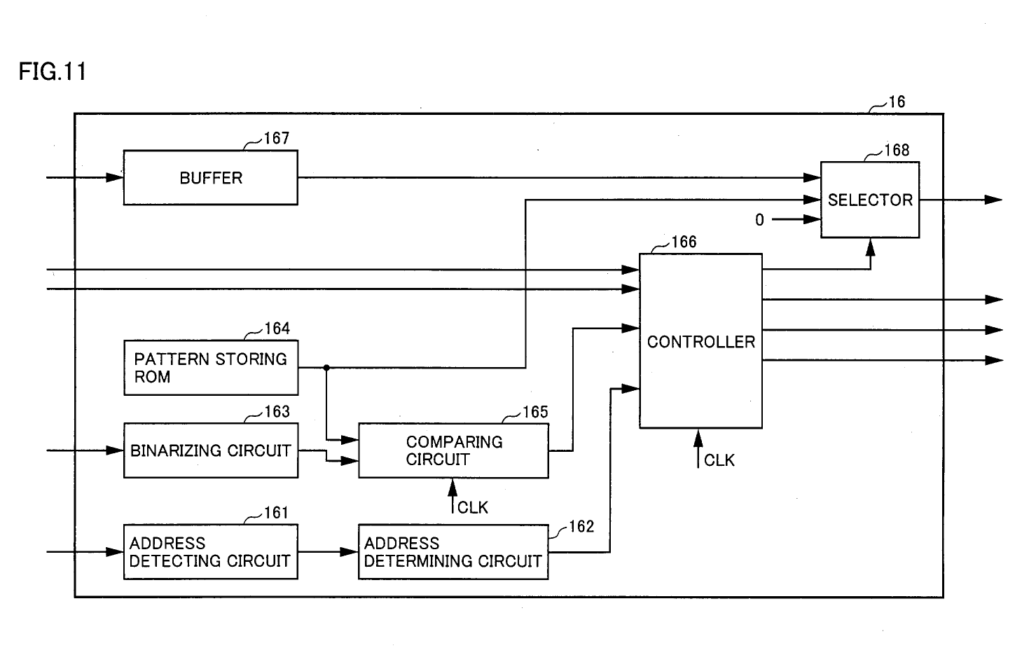

Referring to FIG. 11, magnetic field control circuit 16 includes an address detecting circuit 161, an address determining circuit 162, a binarizing circuit 163, a pattern storing ROM 164, a comparing circuit 165, a controller 166, a buffer 167 and a selector 168.

Address detecting circuit 161 detects the address of the portion on magneto-optical recording medium 10 irradiated with the laser beam based on address signal ADD detected by optical head 13. Address determining circuit 162 determines based on the address sent from address detecting circuit 161 whether the laser beam is emitted to the calibration region bearing the predetermined recording pattern “01010101010 . . . ” or not.

Binarizing circuit 163 compares magneto-optical signal RFA to output reproduced signal RFD in the binary form. Pattern storing ROM 164 stores the predetermined recording pattern “01010101010 . . . ”, and outputs the predetermined recording pattern “01010101010 . . . ” to comparing circuit 165 and selector 168. Comparing circuit 165 compares reproduced signal RFD sent from binarizing circuit 163 with the predetermined recording pattern “01010101010 . . . ” sent from pattern storing ROM 164 in synchronization with external synchronous signal CLK, and detects the error rate of reproduced signal RFD in the method already described with reference to FIG. 8 for outputting the detected error rate to controller 166.

Controller 166 controls selector 168 as follows in synchronization with external synchronous signal CLK. When the intensity of DC magnetic field H_{DCF} is to be calibrated under the control of control circuit 147 included in signal processing control circuit 14, selector 168 selects the predetermined recording pattern “01010101010 . . . ” from pattern storing ROM 164 in response to input of the accessed signal to the calibration region from address determining circuit 162. After the predetermined recording pattern “01010101010 . . . ” is recorded in the calibration region of magneto-optical recording medium 10, controller 166 further controls selector 168 in synchronization with external synchronous signal CLK to select a signal “0” representing the reproduction mode of the signal, and operates in synchronization with external synchronous signal CLK to output the drive signal, which moves iron core 130 of DC magnetic field applying device 12 in radial direction DR2, to fine-motion linear motor 129 based on the iron core position stored in an internal memory (not shown) and listed in the foregoing table 1. Controller 166 stores in the internal memory the error rate, which is provided from comparing circuit 165 when the intensity of DC magnetic field H_{DCF} changes within the range in the table 1. Further, controller 166 detects the appropriate intensity of DC magnetic field H_{DCF}, which provides the error rate of 10⁻⁵ or lower, from the stored error rate, and detects the appropriate position of iron core 130 achieving the appropriate intensity based on the table 1. Further, controller 166 outputs the drive signal for holding iron core 130 in the appropriate position thus detected in synchronization with external synchronous signal CLK.

Further, controller 166 operates in synchronization with external synchronous signal CLK to output the drive signal, which is used for moving the center of stage 122 from point A to point B in the signal reproducing operation, and to control selector 168 to select the signal “0”.

Further, controller 166 operates in synchronization with external synchronous signal CLK to send to rough-motion linear motor 124 the drive signal for moving the center of stage 122 from point B to point A in the signal record operation, and to control selector 168 to select the record signal stored in buffer 167.

Buffer 167 stores the record signal sent from pattern generator 15. Selector 168 selects one of the record signal, the predetermined recording pattern “01010101010 . . . ” and the signal “0” under the control of controller 166, and sends it to magnetic head drive circuit 17.

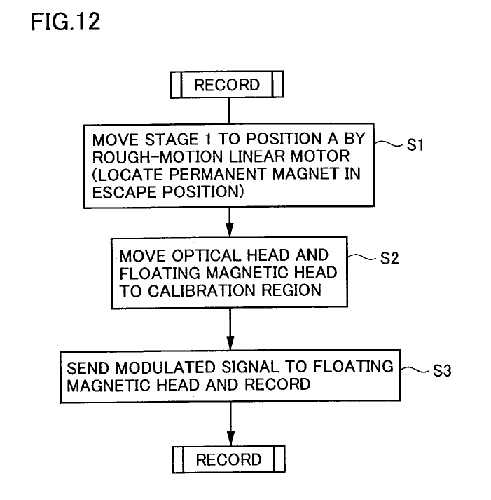

Referring to FIGS. 11-14, description will now be given on the calibration of the intensity of DC magnetic field H_{DCF}. Address detecting circuit 161 detects the address based on address signal ADD sent from optical head 13. Based on the detected address, address determining circuit 162 determines that the laser beam is emitted to the calibration region, and sends results of this determination to controller 166. When controller 166 receives the signal, which indicates that the predetermined recording pattern “01010101010 . . . ” is not yet recorded on magneto-optical recording medium 10, from optical head 13, controller 166 controls selector 168 in synchronization with external synchronous signal CLK to select the predetermined recording pattern “01010101010 . . . ” sent from pattern storing ROM 164. Thereby, the predetermined recording pattern “01010101010 . . . ” is recorded on magneto-optical recording medium 10. Recording of the predetermined recording pattern “01010101010 . . . ” is performed based on a flowchart of FIG. 12. Controller 166 sends the drive signal in synchronization with external synchronous signal CLK to rough-motion linear motor 124 for moving the center of stage 122 in DC magnetic field applying device 12 from point B to point A so that the center of stage 122 moves to point A (step S1), and magnetic head 11 and optical head 13 move to the calibration region (step S2). Selector 168 selects the predetermined recording pattern “01010101010 . . . ” and outputs it to magnetic head drive circuit 17. Magnetic head drive circuit 17 drives magnetic head 11 in accordance with the predetermined recording pattern “01010101010 . . . ”, and magnetic head 11 applies to magneto-optical recording medium 10 the alternating magnetic field, which is modulated in accordance with the predetermined recording pattern “01010101010 . . . ”. Under the control of control circuit 147, laser drive circuit 18 drives the semiconductor laser (not shown) in optical head 13 to emit the laser beam of the intensity required for signal recording. Optical head 13 emits the laser beam of the intensity required for signal recording to the calibration region so that the predetermined recording pattern “01010101010 . . . ” is recorded on magneto-optical recording medium 10 (step S3). Thereby, the operation of recording the predetermined recording pattern “01010101010 . . . ” is completed.

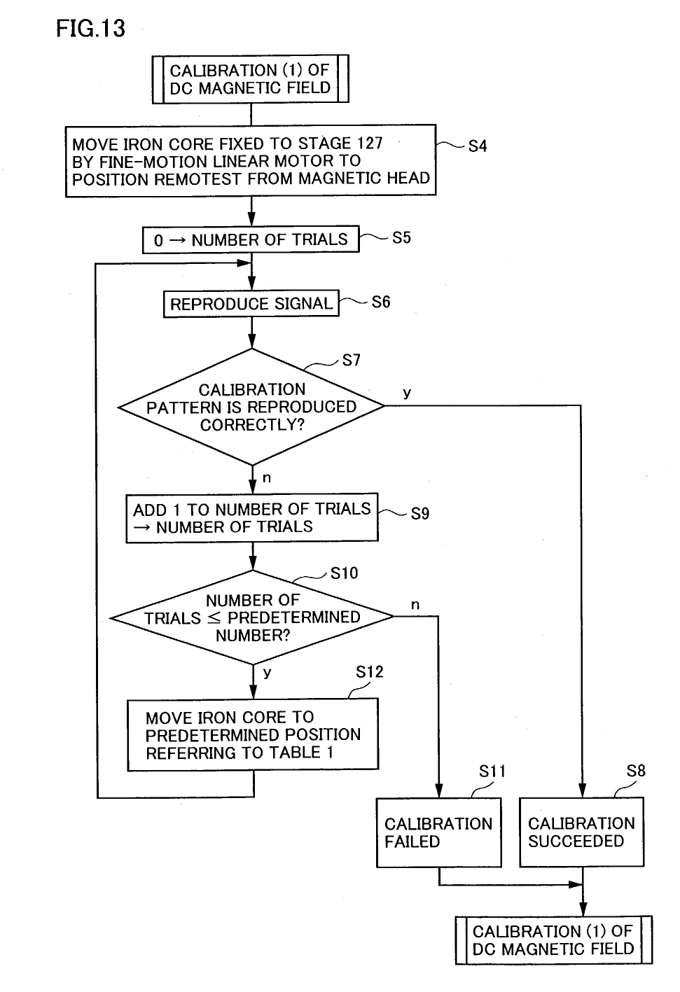

Thereafter, the intensity of DC magnetic field H_{DCF} is calibrated in accordance with the flowchart of FIG. 13. Controller 166 sends the drive signal to fine-motion linear motor 129 for locating iron core 130 fixed to stage 127 of DC magnetic field applying device 12 in a position remotest from core 110 of magnetic head 11, and distance L4 of 2000 μm is set between outgoing surface 133 of iron core 130 and incoming surface 134 of core 110 (step S4). Optical head 13 emits to magneto-optical recording medium 10 the laser beam of the intensity, which raises the temperature of a portion of reproduction layer 3 to or above the compensation temperature. The number of trials is set to “0” (step S5). DC magnetic field H_{DCF} of 6 kA/m in intensity is applied to magneto-optical recording medium 10 in the same direction as the magnetization of the region rich in rare-earth metal within reproduction layer 3, and optical head 13 detects the predetermined recording pattern “01010101010 . . . ” by the domain-enlarging reproduction (step S6). Binarizing circuit 163 receives magneto-optical signal RFA from optical head 13, and outputs reproduced signal RFD in the binary form. Comparing circuit 165 compares binary reproduced signal RFD with the predetermined recording pattern “01010101010 . . . ” sent from pattern storing ROM 164, and detects the error rate of reproduced signal RFD to output it to controller 166. Thereby, controller 166 determines whether the received error rate is smaller than the predetermined reference value of 10⁻⁵ or not (step S7). If the error rate is smaller than 10⁻⁵, the calibration of the intensity of DC magnetic field H_{DCF} succeeded (step S8), and the calibration operation ends. When the error rate is larger than 10⁻⁵, one is added to the number of trials (step S9), and it is determined whether the number of trials exceeds the predetermined value or not (step S1). If the number of trials exceeds the predetermined value, the calibration of the intensity of DC magnetic field H_{DCF} failed (step S11), and the calibration operation ends. If the number of trials does not exceed the predetermined value, controller 166 sends the drive signal to fine-motion linear motor 129 in synchronization with external synchronous signal CLK for moving iron core 130 of DC magnetic field applying device 12 in radial direction DR2 based on the table 1 stored in the internal memory (not shown). Thereby, iron core 130 moves to the position corresponding to the number of trial(s) equal to one in the table 1 (step S12). The loop through steps S6-S12 is repeated until the calibration succeeds or all the trials in the table 1 end.

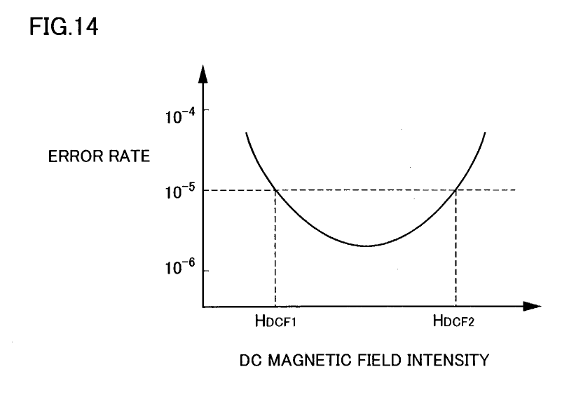

When the intensity of DC magnetic field H_{DCF} increases from 6 kA/m to 56 kA/m, the error rate of reproduced signal RFD lowers with increase in intensity of DC magnetic field H_{DCF}, and then starts to rise with further increase in intensity of DC magnetic field H_{DCF} as shown in FIG. 14. According to the invention, therefore, controller 166 detects two DC magnetic fields H_{DCF1} and H_{DCF2}, which provide the error rate of reproduced signal RFD equal to the predetermined reference value of 10⁻⁵ and operations are performed based on the table 1 to detect the positions of iron core 130, in which DC magnetic field H_{DCF} applied to magneto-optical recording medium 10 has the intensity equal to DC magnetic field H_{DCF1} or H_{DCF2}, and thus, to detect the distance between the outgoing surface 133 of iron core 130 and the incoming surface 134 of core 110. For example, when the relationships of H_{DCF1}=12 kA/m and H_{DCF2}=44 kA/m are detected, positions at 1000 μm and 300 μm are detected as the positions of the iron core. The region between the detected two positions is determined as the appropriate position. Thus, the region from 300 μm to 1000 μm is determined as the appropriate position. Controller 166 sends the drive signal to fine-motion linear motor 129 for holding iron core 130 in the determined appropriate position so that iron core 130 is held in the appropriate position. Thereby, the operation of calibrating the intensity of DC magnetic field H_{DCF} ends.

When the predetermined recording pattern “01010101010 . . . ” of the loaded magneto-optical recording medium 10 is already recorded, the operation of recording the predetermined recording pattern “01010101010 . . . ” is eliminated, and the calibration of the intensity of the predetermined recording pattern “01010101010 . . . ” is performed as shown in FIG. 13.

Description will now be given on the operations of recording and reproducing the signal by magneto-optical disk device 100. First, the signal recording operation will be described. When magneto-optical recording medium 10 is loaded to magneto-optical disk device 100, control circuit 147 controls spindle motor 144 to rotate at a predetermined rotation speed, and spindle motor 144 rotates magneto-optical recording medium 10 at the predetermined rotation speed. Control circuit 147 sends the intensity of the laser beam to be set to laser drive circuit 18. Thereby, laser drive circuit 18 drives the semiconductor laser in optical head 13 based on the received intensity so that the laser beam of the predetermined intensity is emitted to magneto-optical recording medium 10. Optical head 13 detects the beam reflected from magneto-optical recording medium 10, and thereby detects tracking error signal TE, focus error signal FE and fine clock mark signal FCM. Thereafter, the tracking servo and focus servo of objective lens 136 in optical head 13 are turned on as already described so that spindle motor 144 rotates magneto-optical recording medium 10 at the predetermined rotation speed in synchronization with external synchronous signal CLK.

Thereby, control circuit 147 shifts magneto-optical disk device 100 to the record mode. According to the flowchart of FIG. 12, the signal is recorded on magneto-optical recording medium 10. In step S3, controller 166 in magnetic field control circuit 16 controls selector 168 to select the record signal stored in buffer 167, and sends the drive signal to rough-motion linear motor 124 in synchronization with external synchronous signal CLK for moving the center of stage 122 from point B to point A. Rough-motion linear motor 124 moves the center of stage 122 to point A so that DC magnetic field H_{DCF} emerging from permanent magnet 125 does not affect the recording of signal. Selector 168 outputs the record signal to magnetic head drive circuit 17 so that magnetic head drive circuit 17 drives magnetic head 11 based on the record signal. Magnetic head 11 applies the alternating magnetic field modulated with the record signal to magneto-optical recording medium 10. Thereby, recording of the signal to magneto-optical recording medium 10 ends.

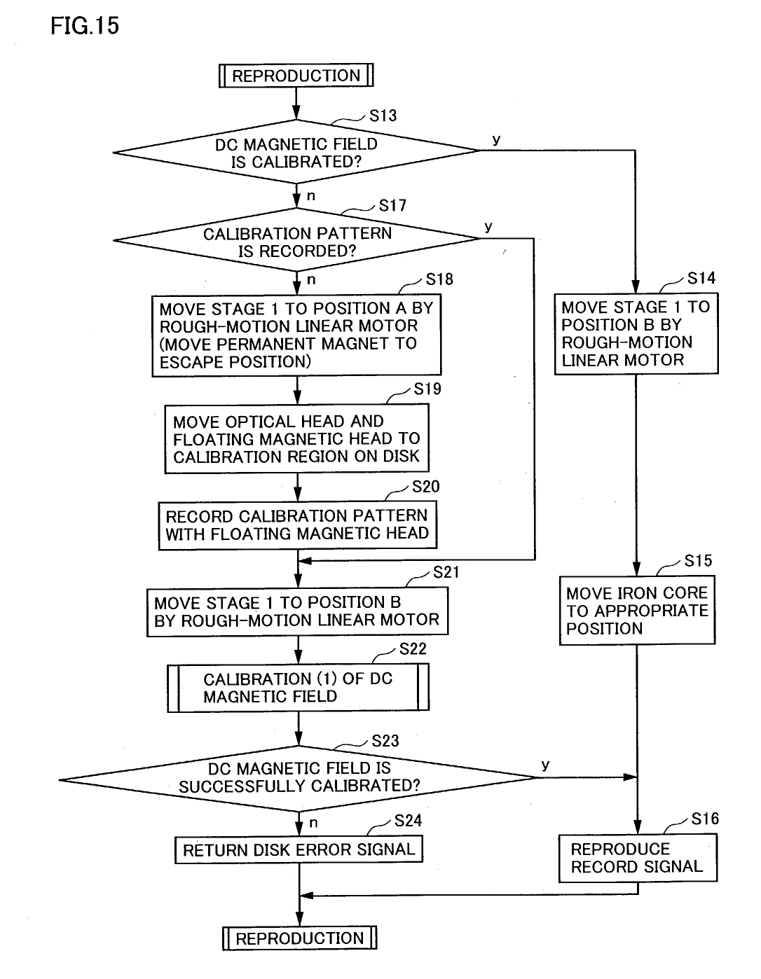

Referring to FIG. 15, the signal reproducing operation will now be described. For reproducing the signal, controller 166 in magnetic field control circuit 16 controls selector 168 to select the signal “0” in synchronization with external synchronous signal CLK. Selector 168 outputs the signal “0” to magnetic head drive circuit 17. Magnetic head drive circuit 17 stops the driving of magnetic head 11 based on signal “0”. When the reproducing operation starts, it is determined whether DC magnetic field H_{DCF} is already calibrated or not (step S13). If already calibrated, rough-motion linear motor 124 moves the center of stage 122 to pint B (step S14). Fine-motion linear motor 129 moves iron core 130 to the appropriate position (step S15), and the domain-enlarging reproduction is effected on magneto-optical recording medium 10 (step S16). In this case, optical head 13 outputs detected magneto-optical signal RFA to binarizing circuit 145, which binarizes magneto-optical signal RFA to send reproduced signal RFD to error correcting circuit 146. Error correcting circuit 146 performs the error correction and demodulation of reproduced signal RFD, and outputs the reproduced data to an external output device (not shown).

When it is determined in step S13 that DC magnetic field H_{DCF} is not yet calibrated, optical head 13 determines whether the predetermined recording pattern “01010101010 . . . ” is recorded on magneto-optical recording medium 10 or not. When it is determined that the predetermined recording pattern “01010101010 . . . ” is not recorded on magneto-optical recording medium 10, controller 166 in magnetic field control circuit 16 controls selector 168 to select the predetermined recording pattern “01010101010 . . . ” from pattern storing ROM 164, and outputs the drive signal for moving the center of stage 122 from point B to point A. Rough-motion linear motor 124 moves the center of stage 122 to point A, and thereby locates permanent magnet 125 in an escape position, where DC magnetic field H_{DCF} does not affect the signal recording (step S18). Magnetic head 11 and optical head 13 are moved to the calibration region (step S19). Selector 168 outputs the record signal to magnetic head drive circuit 17, which drives magnetic head 11 based on the record signal. Magnetic head 11 applies the alternating magnetic field modulated with the record signal to magneto-optical recording medium 10. Thereby, the predetermined recording pattern “01010101010 . . . ” is recorded on magneto-optical recording medium 10 (step S20). Rough-motion linear motor 124 moves the center of stage 122 to point B (step S21), and the intensity of DC magnetic field H_{DCF} is calibrated in accordance with the flowchart of FIG. 13 (step S22).

In step S17, if the predetermined recording pattern “010100101010 . . . ” is already recorded on magneto-optical recording medium 10, the operation moves to step S21.

When the calibration of the intensity of DC magnetic field H_{DCF} succeeded, the processing moves to step S16 for reproducing the signal. When the calibration of the intensity of DC magnetic field H_{DCF} failed, a disk error signal is issued, and magneto-optical disk device 100 ejects magneto-optical recording medium 10. Thereby, the signal reproducing operation ends.

According to the first embodiment, magneto-optical disk device 100 includes magnetic field control circuit 16 for determining the appropriate intensity, which provides the error rate of reproduced signal RFD not exceeding the predetermined reference value, based on reproduced signal RFD obtained by changing the intensity of DC magnetic field H_{DCF}. Therefore, the domain-enlarging reproduction with DC magnetic field can be accurately performed.

[Second Embodiment]

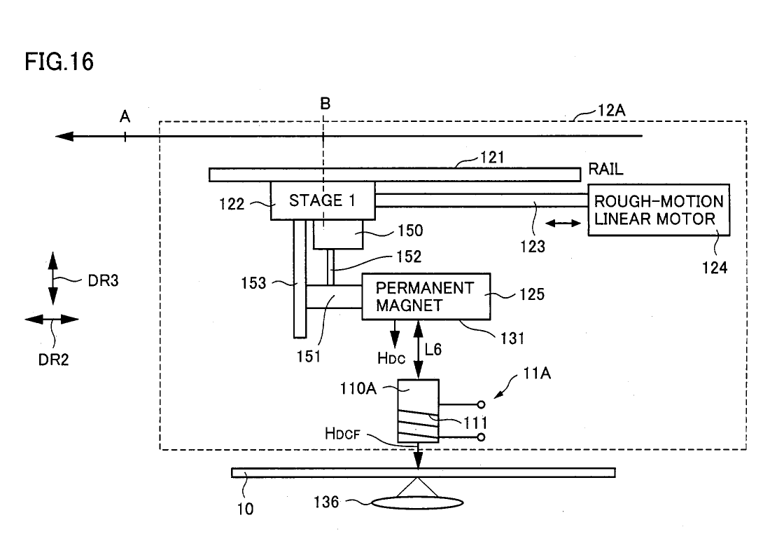

A magneto-optical disk device 200 according to a second embodiment is the same as magneto-optical disk device 100 of the first embodiment except for that a DC magnetic field applying device 12A is employed instead of DC magnetic field applying device 12. Referring to FIG. 16, DC magnetic field applying device 12A includes rails 121 and 153, stages 122 and 151, arms 123 and 152, rough-motion linear motor 124, permanent magnet 125, a fine-motion linear motor 150 and a core 110A. Fine-motion linear motor 150 can expand and contract stepwise an arm 152 via the mechanism already described with reference to FIG. 7, and can move it 10 μm per step. Rail 121, stage 122 and rough-motion linear motor 124 are the same as those in the first embodiment. Fine-motion linear motor 150 is fixed to stage 122, and stage 151 is connected to fine-motion linear motor 150 via arm 152. Permanent magnet 125 is fixed to stage 151. When fine-motion linear motor 150 expand or contract arm 152 in normal direction DR3 of magneto-optical recording medium 10, stage 151 moves in normal direction DR3 along rail 153. Thereby, permanent magnet 125 also moves in normal direction DR3. Fine-motion linear motor 150 moves permanent magnet 125 in normal direction DR3 with an accuracy of 10 μm so that a distance L6 between permanent magnet 125 and core 110A of magnetic head 11A changes within a range from 200 to 2000 μm.

DC magnetic field H_{DC} emerging from permanent magnet 125 is emitted from outgoing surface 131 into core 110A. DC magnetic field H_{DC} is enhanced two or three times by core 110A, and is applied as DC magnetic field H_{DCF} to magneto-optical recording medium 10. Outgoing surface 131 of permanent magnet 125 for DC magnetic field H_{DC} has a size of 1-3 mm per side. Core 110A has a size of 200 μm per side, or has a size of 200 μm in diameter. Accordingly, even when the position of permanent magnet 125 shifts slightly in the in-plane direction of magneto-optical recording medium 10, i.e., in the direction along the surface of magneto-optical recording medium 10, this does not affect the intensity of DC magnetic field H_{DCF}. Coil 111 is wound around core 110A, and core 110A and coil 111 form magnetic head 11A. As already described, however, DC magnetic field H_{DC} emerging from permanent magnet 125 is applied to magneto-optical recording medium 10 via core 110A of magnetic head 11A in the signal reproducing operation so that core 110A of magnetic head 11A forms a component of DC magnetic field applying device 12A.

DC magnetic field applying device 12A likewise changes the intensity of DC magnetic field H_{DCF} by changing the distance from permanent magnet 125 to core 110A of magnetic head 11A, and thereby changing the density of magnetic flux emitted from permanent magnet 125 to core 110A.

In DC magnetic field applying device 12A, rough-motion linear motor 124 changes the center of stage 122 from point B to point A in the signal recording operation, and changes the center of stage 122 from point A to point B in the signal reproducing operation.

In the second embodiment, permanent magnet 125 moves in normal direction DR3 of magneto-optical recording medium 10 to change the intensity of DC magnetic field H_{DCF}, and the position of permanent magnet 125 is adjusted so that optical head 13 detects the error rate of reproduced signal RFD not exceeding 10⁻⁵. Thereby, the intensity of DC magnetic field is calibrated. Permanent magnet 125 moves within the range represented by the table 2, and the position of the permanent magnet successively changes in accordance with increase in number of trial(s) from 0 to 7 as shown in the table 2. Although the table 2 includes the lower limit of 200 μm. This is for the purpose of preventing such a situation that permanent magnet 125 collides with magnetic head 11A, and magnetic head 11A collides with magneto-optical recording medium 10 to break it.

TABLE 2

| Number of | Iron Core Position | Disk Surface Magnetic Field |
|---|---|---|
| Trials | (μm) | (kA/m) |
| 0 | 2000 | 6 |
| 1 | 1000 | 16 |
| 2 | 500 | 28 |
| 3 | 200 | 56 |
| 4 | 1500 | 12 |
| 5 | 750 | 20 |
| 6 | 400 | 40 |
| 7 | 300 | 44 |

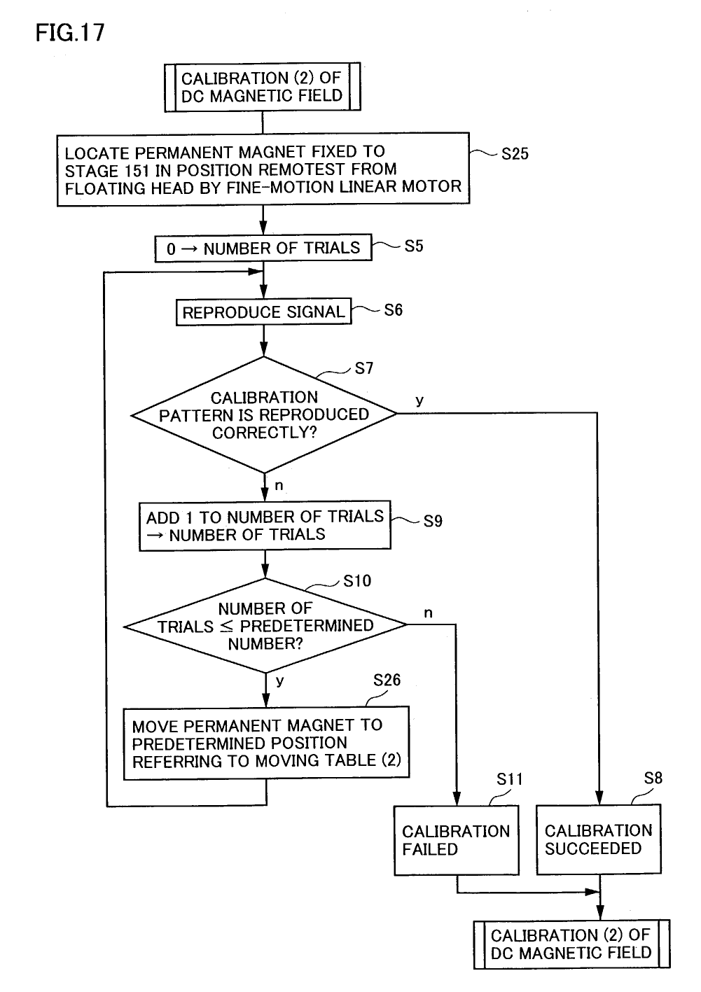

When the intensity of DC magnetic field H_{DCF} is to be calibrated, controller 166 of magnetic field control circuit 16 stores the table 2 in its internal memory. A flowchart of FIG. 17 is used for calibrating the intensity of DC magnetic field H_{DCF}, and this flow is the same as that in FIG. 13 except for that steps S25 and S26 are employed instead of steps S4 and S12, respectively. In the first embodiment, the intensity of DC magnetic field H_{DCF} is calibrated by moving iron core 130 in the radial direction DR2 of magneto-optical recording medium 10. In the second embodiment, however, the intensity of DC magnetic field H_{DCF} is changed by moving permanent magnet 125 in normal direction DR3 of magneto-optical recording medium 10. In step S25, therefore, permanent magnet 125 is moved in normal direction DR3, and is located in the position remotest from core 110A. In step S26, the intensity of DC magnetic field H_{DCF} is changed by moving permanent magnet 125 in normal direction DR3 based on the position of the permanent magnet represented in the table 2. In the second embodiment, the distance between permanent magnet 125 and core 110A changes so that the density of magnetic flux impinging on core 110A changes, and thereby the intensity of DC magnetic field H_{DCF} changes, similarly to the first embodiment.

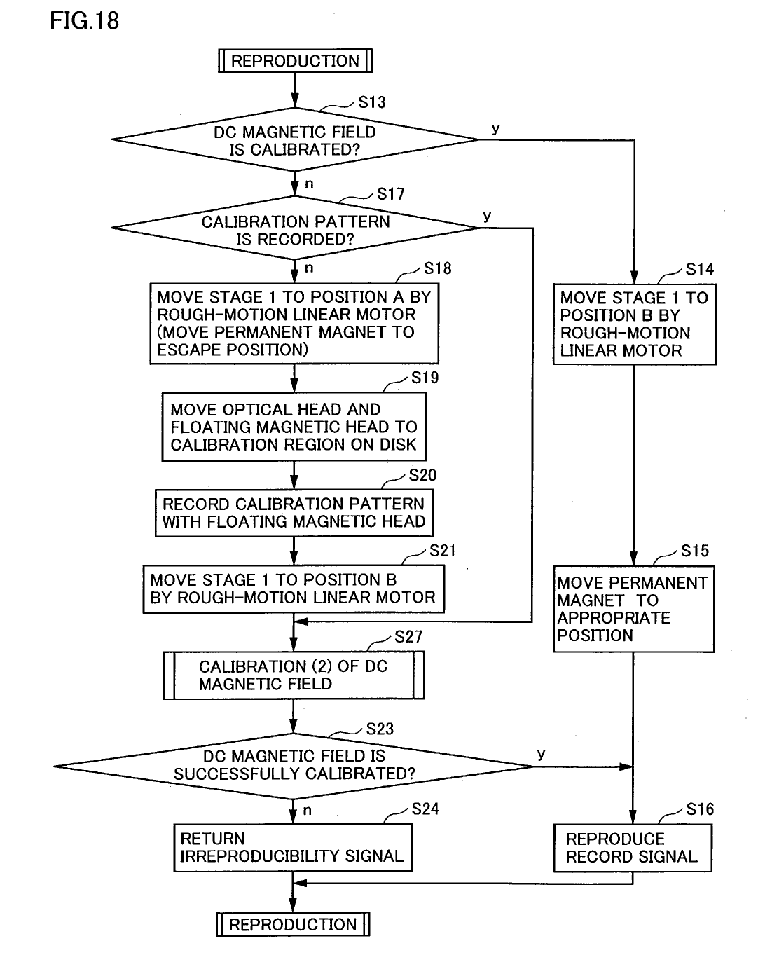

A flowchart of the signal reproduction from magneto-optical recording medium 10 is illustrated in FIG. 18. This flowchart is the same as that in FIG. 15 except for that step S22 in FIG. 15 is replaced with a step S27, in which the intensity of DC magnetic field H_{DCF} is calibrated as illustrated in FIG. 17.

Structures and operations other than the above are the same as those in the first embodiment.

According to the second embodiment, therefore, magneto-optical disk device 200 includes magnetic field control circuit 16 for determining the appropriate magnetic field intensity, which provides the error rate of reproduced signal RFD not exceeding the predetermined reference value, based on reproduced signal RFD obtained while changing the intensity of DC magnetic field H_{DCF} by moving permanent magnet 125 in normal direction DR3 of magneto-optical recording medium 10. Therefore, the domain-enlarging reproduction with the DC magnetic field can be accurately performed.

[Third Embodiment]

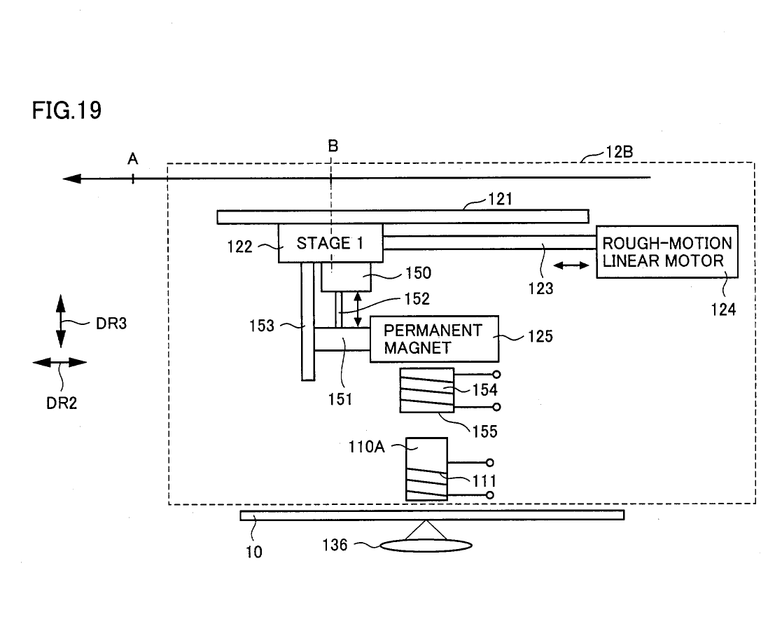

A magneto-optical disk device 300 according to a third embodiment employs a DC magnetic field applying device 12B including, as shown in FIG. 19, rails 121 and 153, stages 122 and 151, arms 123 and 152, rough-motion linear motor 124, permanent magnet 125, fine-motion linear motor 150, core 110A, an iron core 154 and a coil 155. Rail 121, stage 122 and rough-motion linear motor 124 are the same as those in the first embodiment. Fine-motion linear motor 150, stage 151, arm 152 and rail 153 are the same as those in the second embodiment.

Iron core 154 is spaced from permanent magnet 125 by a distance from 0 to 100 μm, and coil 155 is wound around iron core 154. Iron core 154 is fixed to stage 151 via a support member (not shown). When rough-motion linear motor 124 moves stage 122 in radial direction DR2 of magneto-optical recording medium 10, iron core 154 moves in radial direction DR2 together with permanent magnet 125. Iron core 154 has a size of 1 mm per side or of 1 mm in diameter, and core 110A has a size of 200 μm per side or of 200 μm in diameter. Accordingly, even if the position of iron core 154 is shifted slightly in the in-plane direction of magneto-optical recording medium 10, this does not affect the intensity of DC magnetic field H_{DCF}.

In DC magnetic field applying device 12B, DC magnetic field H_{DC} emerging from permanent magnet 125 enters iron core 154 without reducing its intensity, and is emitted from iron core 154 into core 110A with the intensity increased two or three times so that it is applied as DC magnetic field H_{DCF} to magneto-optical recording medium 10.

Similarly to the devices already described, DC magnetic field applying device 12B changes the intensity of DC magnetic field H_{DCF} by changing the distance from iron core 154 to core 110A of magnetic head 11A, and thereby changing the density of magnetic flux applied from permanent magnet 125 to core 110A through iron core 154.

DC magnetic field applying device 12B also has a function of positioning iron core 154 and core 110A in the in-plane direction. More specifically, when magnetic head 11A produces the magnetic field, which changes the density of magnetic flux emitted from magnetic head 11A to iron core 154, the number of lines of flux crossing coil 155 changes to cause electromagnetic induction. Thereby, a potential difference occurs between the opposite ends of coil 155, and a current flows through coil 155. Therefore, the current flowing through coil 155 is detected by an ammeter, and rough-motion linear motor 124 adjusts the position of iron core 154 in the in-plane direction to achieve a predetermined current value. In the operation of adjusting the position of iron core 154 in the in-plane direction, a distance of 200 μm is held between iron core 154 and core 110A. In the operation of adjusting the position of iron core 154 in the in-plane direction, the magnetic head 11A may produce the magnetic field of the intensity changing in a sinusoidal form or a triangular-wave form. In general, this magnetic field is merely required to change the magnetic flux incident to iron core 154 with time.

After the positions of iron core 154 and core 110A in the in-plane direction are adjusted, the distance between iron core 154 and core 110A is change within the range of the table 2 so that the intensity of DC magnetic field H_{DCF} applied to magneto-optical recording medium 10 is calibrated.

Coil 111 is wound around core 110A to form magnetic head 11A. However, the DC magnetic field H_{DC} emerging from permanent magnet 125 is applied to magneto-optical recording medium 10 through core 110A of magnetic head 11A in the signal reproducing operation. Therefore, core 110A of magnetic head 11A is one of the components of DC magnetic field applying device 12B.

In the DC magnetic field applying device 12B, rough-motion linear motor 124 moves the center of stage 122 from point B to point A in the signal recording operation, and moves the center of stage 122 from point A to point B in the signal reproducing operation.

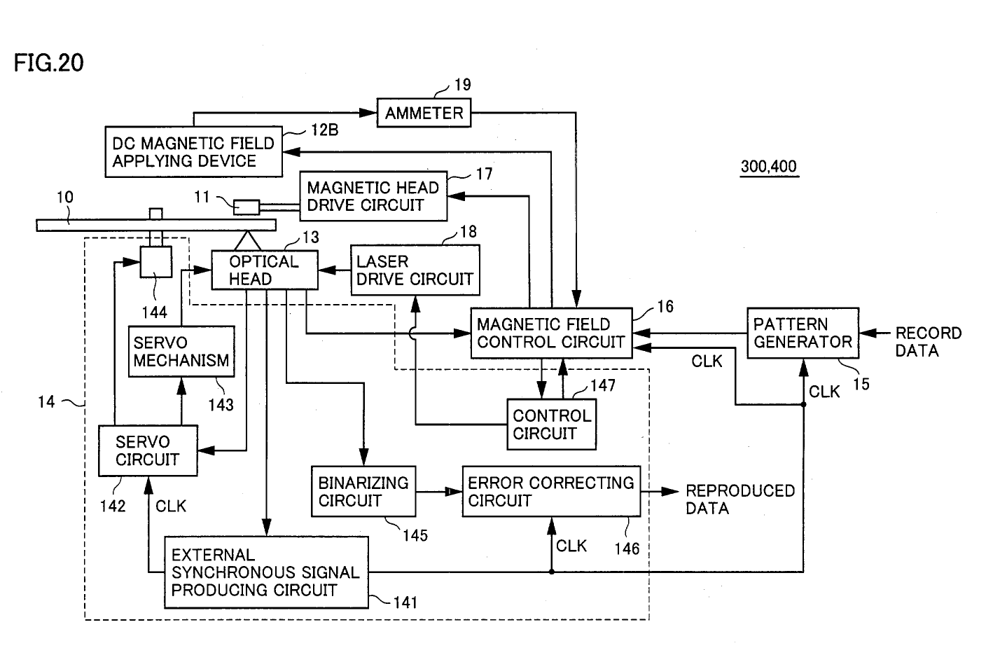

Referring to FIG. 20, magneto-optical disk device 300 according to the third embodiment differs from magneto-optical disk device 100 shown in FIG. 10 in that DC magnetic field applying device 12B is employed instead of DC magnetic field applying device 12, and an ammeter 19 is additionally employed.

Ammeter 19 detects the value of current flowing through coil 155 in DC magnetic field applying device 12B, and sends the results to magnetic field control circuit 16.

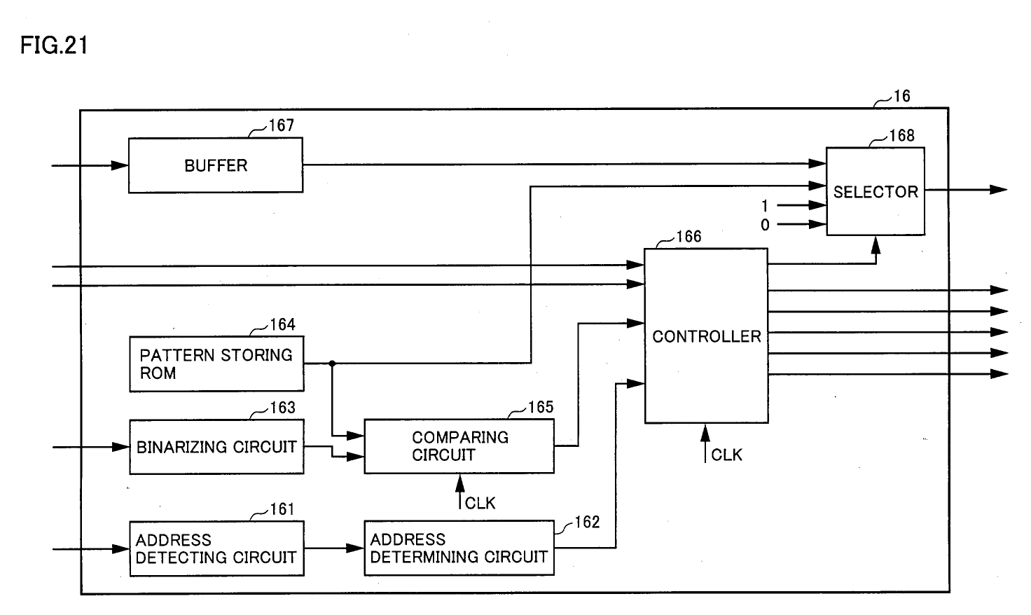

As shown in FIG. 21, magnetic field control circuit 16 has the same structure as that shown in FIG. 11, but differs therefrom in function of controller 166. In the operation of adjusting the positions of iron core 154 and core 110A in the in-plane direction, controller 166 controls selector 168 in synchronization with external synchronous signal CLK to select a signal “1” for generating from magnetic head 11A the magnetic field, which changes the density of magnetic flux emitted from magnetic head 11A to iron core 154. Controller 166 sends the drive signal to fine-motion linear motor 150 in synchronization with external synchronous signal CLK, and fine-motion linear motor 150 keep a distance of 200 μm between iron core 154 and core 110A. Controller 166 sends the drive signal to rough-motion linear motor 124 in synchronization with external synchronous signal CLK, and rough-motion linear motor 124 moves stage 122 in the in-plane direction of magneto-optical recording medium 10. Stage 122 is moved within the range represented in a table 3. In the table 3, “Position” indicates the distance between the center of stage 122 and point B. Controller 166 includes an internal memory storing the table 3.

TABLE 3

| Number of | Position in x Direction |
|---|---|
| Trials | (mm) |
| 0 | 0 |
| 1 | 0.5 |
| 2 | −0.5 |
| 3 | −1 |
| 4 | 1 |
| 5 | 1.5 |
| 6 | 2 |
| 7 | 2.5 |
| 8 | −2.5 |
| 9 | −2 |
| 10 | −1.5 |

Thereby, ammeter 19 detects the value of current flowing through coil 155, and sends it to controller 166. Controller 166 determines, as the optimum position of iron core 154, the position of iron core 154, in which coil 155 passes the current of a value equal to or larger than 10% of the current value of 200 mA required for producing the magnetic field of 16 kA/m equal to the peak intensity of the alternating magnetic field produced from magnetic head 11A. This is because the number of lines of flux crossing coil 155 changes to the largest extent when the current of 20 mA or more is passed through coil 155 by electromagnetic induction in the structure having a distance of 200 μm between iron core 154 and core 110A. When the optimum position of iron core 154 is determined, controller 166 sends the drive signal for achieving this optimum position to rough-motion linear motor 124 in synchronization with external synchronous signal CLK, and rough-motion linear motor 124 locates iron core 154 in the optimum position.

Thereafter, the intensity of DC magnetic field H_{DCF} is calibrated by moving permanent magnet 125 in normal direction DR3 of magneto-optical recording medium 10 in the same manner as that of the second embodiment already described.

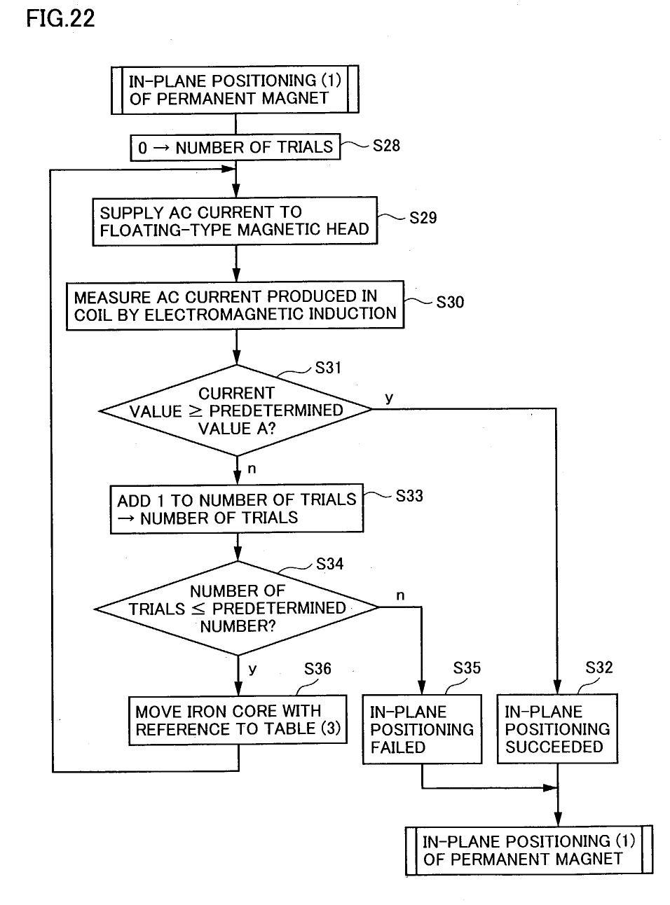

Referring to FIG. 22, description will now be given on a flow of the operation of positioning permanent magnet 125 and thus iron core 154 in the in-plane direction. When the operation starts, the number of trials is set to “0” (step S28), and coil 111 of magnetic head 11A is supplied with a current for producing the magnetic field, which changes the number of lines of flux incident to iron core 154 (step S29). Ammeter 19 detects the current passed through coil 155 by electromagnetic induction (step S30). It is determined whether the detected current value is lower than 20 mA or not (step S31). If it is not lower than 20 mA, the position adjustment in the in-plane direction has succeeded, and the operation ends (step S32). If the current value is lower than 20 mA, one is added to the number of trials (step S33), and it is determined whether the number of trials exceeds a predetermined value or not (step S34). If the number of trials exceeds the predetermined value, the in-plane position adjustment has failed, and the operation ends (step S35). If the number of trials does not exceed the predetermined value, iron core 154 is moved in the in-plane direction based on the table 3 (step S36). The loop between steps S29 and S36 is repeated until the position adjustment in the in-plane direction succeeds, or until the movement of iron core 154 is completed within the whole range in the table 3.

After the position adjustment of iron core 154 in the in-plane direction ends, the intensity of DC magnetic field H_{DCF} is calibrated by moving permanent magnet 125 in normal direction DR3 of magneto-optical recording medium 10. A flow of the operation of calibrating the intensity of DC magnetic field H_{DCF} is the same as that illustrated in FIG. 17.

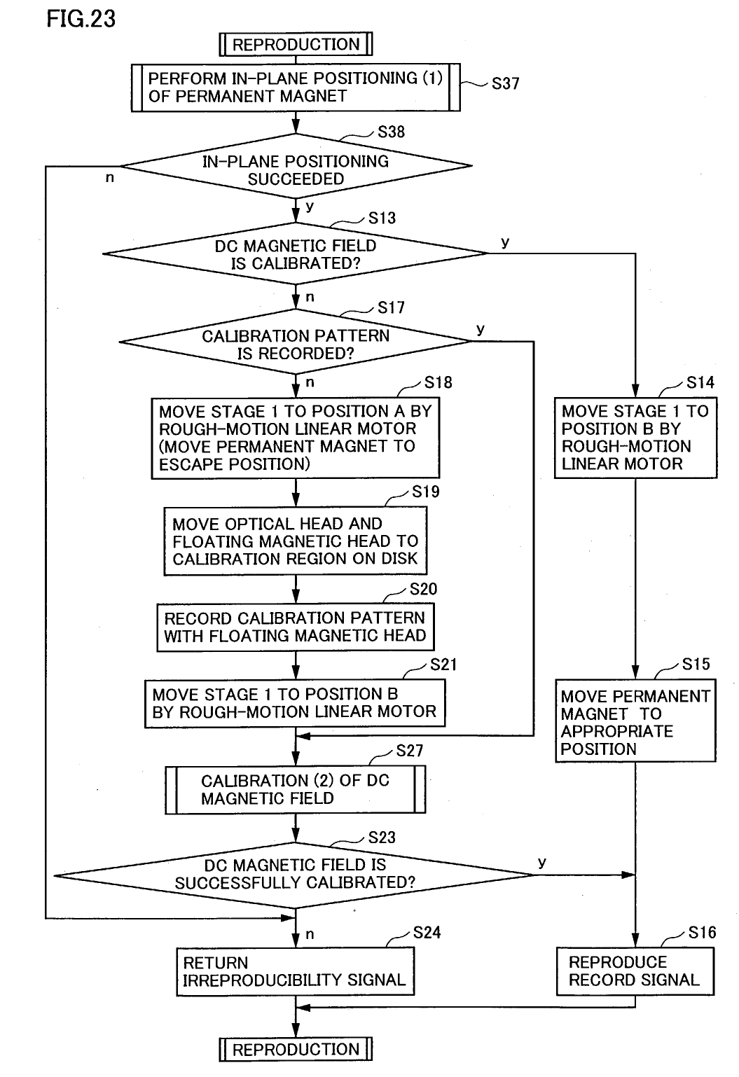

A flow of the signal reproducing operation in magneto-optical disk device 300, which is illustrated in FIG. 23, is the same as that illustrated in FIG. 18 except for that steps S37 and S38 are added.

In step S37, the position of permanent magnet 125 and thus the position of iron core 154 are adjusted in the in-plane direction as already described with reference to FIG. 22. In step S38, it is determined whether the position adjustment of permanent magnet 125 in the in-plane direction succeeded or not. If not, the operation moves to step S24. If it is determined in step S38 that the position adjustment of permanent magnet 125 in the in-plane direction succeeded, the operation moves to step S13, and the signal reproduction is performed through the same steps as those already described with reference to FIG. 18.

Referring to FIGS. 20 and 21 again, description will now be given on the operation of magneto-optical disk device 300 for positioning permanent magnet 125 and thus iron core 154 in the in-plane direction. Controller 166 of magnetic field control circuit 16 outputs the drive signal to fine-motion linear motor 150 in synchronization with external synchronous signal CLK for holding a distance of 200 μm between iron core 154 and core 110A so that fine-motion linear motor 150 holds the distance of 200 μm between iron core 154 and core 110A. Thereby, controller 166 outputs the drive signal to magnetic head drive circuit 17 in synchronization with external synchronous signal CLK for producing the magnetic field, which changes the magnetic flux emitted from magnetic head 11A to iron core 154 with time. Magnetic head drive circuit 17 drives magnetic head 11A based on the drive signal sent from controller 166. In synchronization with external synchronous signal CLK, controller 166 produces the drive signal based on the table 3 for moving stage 122 in the in-plane direction of magneto-optical recording medium 10, and sends it to rough-motion linear motor 124. Rough-motion linear motor 124 moves stage 122 in the in-plane direction based on the drive signal sent from controller 166. Ammeter 19 detects the value of current flowing through coil 111 of magnetic head 11A, and sends the detected current value to magnetic field control circuit 16. Thereby, controller 166 of magnetic field control circuit 16 determines the appropriate position of iron core 154, at which the current value of 20 mA or more is detected, based on the received current value, and sends the drive signal to rough-motion linear motor 124 in synchronization with external synchronous signal CLK for holding iron core 154 in the determined position. Rough-motion linear motor 124 moves stage 122 in the in-plane direction based on the drive signal sent from controller 166, and holds iron core 154 in the appropriate position. In this manner, the position adjustment of iron core 154 in the in-plane direction ends.

Operations other than the above are the same as those of the second embodiment already described.

According to the third embodiment, magneto-optical disk device 300 is provided with magnetic field control circuit 16, which adjusts the position of permanent magnet 125 by moving permanent magnet 125 in the in-plane direction of magneto-optical recording medium 10 so that the current caused by the electromagnetic induction may take the maximum value, and determines the appropriate magnetic field intensity, which provides the error rate of reproduced signal RDF not exceeding the predetermined reference value, based on reproduced signal RFD obtained while changing the intensity of DC magnetic field H_{DCF} by moving permanent magnet 125 in normal direction DR3 of magneto-optical recording medium 10. Accordingly, the domain-enlarging reproduction with the DC magnetic field can be accurately performed.

[Fourth Embodiment]

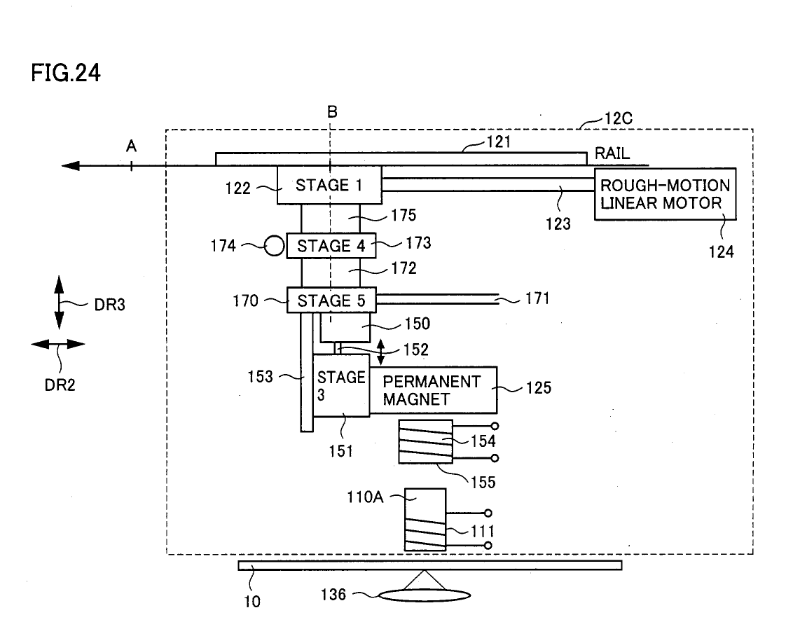

According to a fourth embodiment, a magneto-optical disk device 400 employs a DC magnetic field applying device 12C shown in FIG. 24. DC magnetic field applying device 12C differs from DC magnetic field applying device 12B of the third embodiment in that a stage 170, rails 171 and 174, a fine-motion linear motor 172, a stage 173 and a fine-motion linear motor 175 are additionally employed. Fine-motion linear motor 150 is fixed to stage 170. Fine-motion linear motor 172 is fixed to stage 173, and moves stage 170 in radial direction DR2 of magneto-optical recording medium 10 along rail 171. Fine-motion linear motor 175 is fixed to stage 122, and moves stage 173 along rail 174 in a tangential direction DR4 perpendicular to the sheet of FIG. 24) of magneto-optical recording medium 10 along rail 174.

In DC magnetic field applying device 12C, a distance between iron core 154 and core 110A of magnetic head 11A is changed to change the density of magnetic flux emitted from permanent magnet 125 through iron core 154 to core 110A, and thereby the intensity of DC magnetic field H_{DCF} is changed.

In DC magnetic field applying device 12C, rough-motion linear motor 124 roughly adjusts the position of iron core 154 in radial direction DR2, and fine-motion linear motor 172 finely adjusts the position thereof. In DC magnetic field applying device 12C, fine-motion linear motor 175 roughly and finely adjusts the position of iron core 154 in tangential direction DR4. Fine-motion linear motors 172 and 175 move stages 170 and 173 stepwise via the same mechanisms as those shown in FIG. 7, respectively.

Rough-motion linear motor 124 moves stage 122 in radial direction DR2 based on the table 3. Fine-motion linear motor 175 moves stage 173 based on a table 4 when the position of iron core 154 is to be adjusted roughly in tangential direction DR4, and moves stage 173 based on a table 5 when the position of iron core 154 is to be adjusted finely. Fine-motion linear motor 172 moves stage 170 in radial direction DR2 based on the table 5.

TABLE 4

| Number of | Position in y direction |
|---|---|
| Trials | (mm) |
| 0 | 0 |
| 1 | 0.5 |
| 2 | −0.5 |
| 3 | −1 |
| 4 | 1 |
| 5 | 1.5 |
| 6 | 2 |
| 7 | 2.5 |
| 8 | −2.5 |
| 9 | −2 |
| 10 | −1.5 |

TABLE 5

| Number (n) of | Position in x Direction | Position in y Direction |
|---|---|---|
| Trials | (μm) | (μm) |
| 0-5 | n * 50 | 0 |
| 6-11 | (n mod 6) * 50 | 50 |
| 12-17 | (n mod 6) * 50 | 100 |
| 18-23 | (n mod 6) * 50 | 150 |
| 24-29 | (n mod 6) * 50 | 200 |
| 30-35 | (n mod 6) * 50 | 250 |
| 36-41 | (n mod 6) * 50 | −50 |
| 42-47 | (n mod 6) * 50 | −100 |
| 48-53 | (n mod 6) * 50 | −150 |
| 54-59 | (n mod 6) * 50 | −200 |
| 60-65 | (n mod 6) * 50 | −250 |
| 66-71 | −n * 50 | 0 |
| 72-77 | −(n mod 6) * 50 | 50 |
| 78-83 | −(n mod 6) * 50 | 100 |
| 84-89 | −(n mod 6) * 50 | 150 |
| 90-95 | −(n mod 6) * 50 | 200 |
| 96-101 | −(n mod 6) * 50 | 250 |
| 102-107 | −(n mod 6) * 50 | −50 |
| 108-113 | −(n mod 6) * 50 | −100 |
| 114-119 | −(n mod 6) * 50 | −150 |
| 120-125 | −(n mod 6) * 50 | −200 |
| 126-131 | −(n mod 6) * 50 | −250 |

In the operation of adjusting the position of iron core 154 by moving stage 122 in radial direction DR2 by rough-motion linear motor 124, the adjusted position is determined as the appropriate position when ammeter 19 detects the current value equal to 10% or more of the value of current flowing through coil 111 of magnetic head 11A. In the operation of adjusting the position of iron core 154 by moving stage 170 in radial direction DR2 by fine-motion linear motor 172, the adjusted position is determined as the optimum position when ammeter 19 detects the current value equal to 18% or more of the value of current flowing through coil 111 of magnetic head 11A. This reference value equal to 18% of current value of the coil 111 is detected when 90% of the magnetic flux produced from magnetic head 11A is detected, assuming that core 110A of magnetic head 11A has a size of 200 μm per side (or 200 μm in diameter) and iron core 154 has a size of 1000 μm per side (or 1000 μm in diameter).

In the operation of roughly adjusting the position of iron core 154 by moving stage 173 in tangential direction DR4 by fine-motion linear motor 175, the adjusted position is determined as the appropriate position when ammeter 19 detects the current value equal to 13% or more of the value of current flowing through coil 111 of magnetic head 11A. In the operation of finely adjusting the position of iron core 154, the adjusted position is determined as the optimum position when ammeter 19 detects the current value equal to 18% or more of the value of current flowing through coil 111 of magnetic head 11A. This reference value equal to 13% of current value of the coil 111 is detected when 65% of the magnetic flux produced from magnetic head 11A is detected, assuming that core 110A of magnetic head 11A has a size of 200 μm per side (or 200 μm in diameter) and iron core 154 has a size of 1000 μm per side (or 1000 μm in diameter).

Structures and operations other than the above are the same as those of DC magnetic field applying device 12B of the third embodiment.

In the fourth embodiment, magnetic field control circuit 16 has the same structure as that in FIG. 21, but differs therefrom in function. Controller 166 stores the tables 2, 3, 4 and 5 in its internal memory (not shown). Controller 166 operates in synchronization with external synchronous signal CLK to drive fine-motion linear motor 150 based on the table 2, to drive rough-motion linear motor 124 based on the table 3, to drive fine-motion linear motor 175 based on the table 4, and to drive fine-motion linear motors 172 and 175 based on the table 5.

In the operation of adjusting the position of permanent magnet 125 and iron core 154 in normal direction DR3 of magneto-optical recording medium 10 based on the table 2, controller 166 determines the position, where reproduced signal RFD detected by optical head 13 has the error rate of 10⁻⁵ or lower, as the appropriate position, and drives fine-motion linear motor 150 in synchronization with external synchronous signal CLK for holding permanent magnet 125 and iron core 154 in the determined appropriate position. Further, in the operation of adjusting the position of permanent magnet 125 and iron core 154 in radial direction DR2 of magneto-optical recording medium 10 based on the table 3, controller 166 determines the position, where the current value sent from ammeter 19 is equal to 10% or more of the value of current flowing through coil 111 of magnetic head 111A, as the appropriate position, and drives rough-motion linear motor 124 in synchronization with external synchronous signal CLK for holding permanent magnet 125 and iron core 154 in the determined appropriate position. In the operation of adjusting the position of permanent magnet 125 and iron core 154 in radial direction DR3 of magneto-optical recording medium 10 based on the table 5, controller 166 determines the position, where the current value sent from ammeter 19 is equal to 18% or more of the value of current flowing through coil 111 of magnetic head 111A, as the appropriate position, and drives fine-motion linear motor 172 in synchronization with external synchronous signal CLK for holding permanent magnet 125 and iron core 154 in the determined appropriate position. In the operation of adjusting the position of permanent magnet 125 and iron core 154 in tangential direction DR4 of magneto-optical recording medium 10 based on the table 4, controller 166 determines the position, where the current value sent from ammeter 19 is equal to 13% or more of the value of current flowing through coil 111 of magnetic head 10A, as the appropriate position, and drives fine-motion linear motor 175 in synchronization with external synchronous signal CLK for holding permanent magnet 125 and iron core 154 in the determined appropriate position. In the operation of adjusting the position of permanent magnet 125 and iron core 154 in tangential direction DR4 of magneto-optical recording medium 10 based on the table 5, controller 166 determines the position, where the current value sent from ammeter 19 is equal to 18% or more of the value of current flowing through coil 111 of magnetic head 110A, as the appropriate position, and drives fine-motion linear motor 175 in synchronization with external synchronous signal CLK for holding permanent magnet 125 and iron core 154 in the determined appropriate position.

Functions other than the above are the same as those of the magnetic field control circuit of the third embodiment.

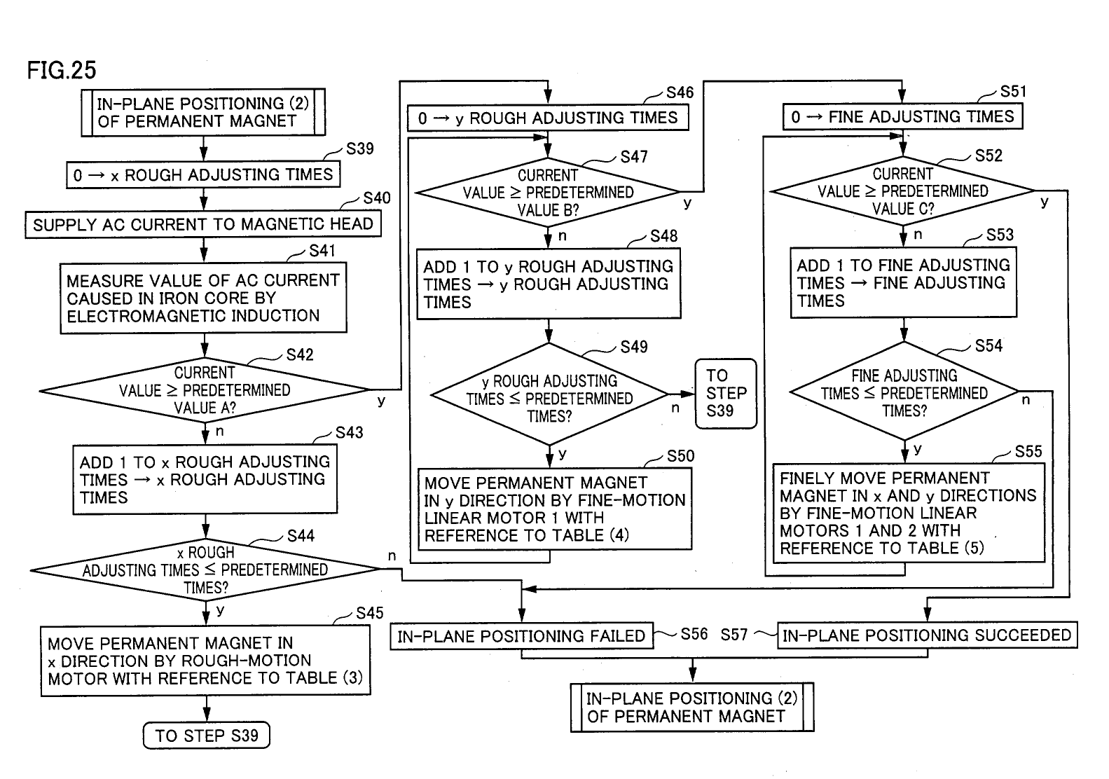

Referring to FIG. 25, description will now be given on a flow of the position adjustment of permanent magnet 125 and iron core 154 in radial and tangential directions DR2 and DR4 of magneto-optical recording medium 10. In FIG. 25, “x direction” means radial direction DR2 of magneto-optical recording medium 10, and “y direction” means tangential direction DR4 of magneto-optical recording medium 10.

When the position adjusting operation starts, the number of times of rough position adjustment in radial direction DR2 is set to “0” (step S39), and magnetic head drive circuit 17 passes an AC current through coil 111 of magnetic head 11A (step S40). Thereby, the number of lines of flux incident to iron core 154 changes with time so that a potential difference is caused in coil 155 by the electromagnetic induction, and ammeter 19 detects the current flowing through coil 155 (step S41). It is determined whether the current value detected by ammeter 19 is equal to 10% or more of the value of current flowing through coil 111 of magnetic head 11A or not (step S42). If it is smaller than 10%, the times of rough position adjustment in radial direction DR2 are incremented by one (step S43). It is determined whether the times of rough position adjustment in radial direction DR2 exceed the predetermined times or not (step S44). If the times do not exceed the predetermined times, rough-motion linear motor 124 moves stage 122 in radial direction DR2 based on the table 3 (step S45). Steps S40-S45 are repeated until the rough position adjustment of permanent magnet 125 and iron core 154 in radial direction DR2 is completed, or until the position of permanent magnet 125 and iron core 154 is changed based on all the conditions in the table 3.

When the times of rough position adjustment in radial direction DR2 exceed the predetermined times in step S44, the position adjustment in the in-plane direction fails (step S56), and the adjusting operation ends. When ammeter 19 detects in step S42 the current value equal to 10% or more of the value of current flowing through coil 111 of magnetic head 11A, the number of times of rough position adjustment in tangential direction DR4 is set to “0” (step S46). It is determined whether the current value detected by ammeter 19 is equal to 13% or more of the value of current flowing through coil 111 of magnetic head 11A or not (step S47). If it is smaller than 13%, the times of rough position adjustment in tangential direction DR4 is incremented by one (step S48). It is determined whether the times of rough position adjustment in tangential direction DR4 exceed the predetermined value or not (step S49). If not, fine-motion linear motor 175 moves stage 173 in tangential direction DR4 based on the table 4 (step S50). Steps S47-S50 are repeated until the rough position adjustment of permanent magnet 125 and iron core 154 in tangential direction DR4 is completed, or until the position of permanent magnet 125 and iron core 154 is changed based on all the conditions in the table 4.

When the times of rough position adjustment in tangential direction DR4 exceed the predetermined times in a step S49, the operation moves to step S39, and the position adjustment of permanent magnet 125 and iron core 154 is performed again. When ammeter 19 detects the current value of 13% or more of the value of current flowing through coil 111 of magnetic head 11A in step S48, the number of times of fine position adjustment in each of radial and tangential directions DR2 and DR4 is set to “0” (step S51). It is determined whether the current value detected by ammeter 19 is smaller than 18% of the value of current flowing through coil 111 of magnetic head 11A or not (step S52). If it is smaller than 18%, the number of the times of fine position adjustment in each of radial and tangential directions DR2 and DR4 is incremented by one (step S53). It is determined whether the times of rough position adjustment in each of radial and tangential directions DR2 and DR4 exceed the predetermined times or not (step S54). If not, fine-motion linear motor 172 moves stage 170 in radial direction DR2 based on the table 5, and fine-motion linear motor 175 moves stage 173 in tangential direction DR4 based on the table 5 (step S55). Steps S52-S55 are repeated until the fine position adjustment of permanent magnet 125 and iron core 154 in radial and tangential directions DR2 and DR4 is completed, or until the position of permanent magnet 125 and iron core 154 is changed based on all the conditions in the table 5.

If the current value detected by ammeter 19 is equal to 18% or more of the value of current flowing through coil 111 of magnetic head 11A in step S52, the position adjustment of permanent magnet 125 and iron core 154 in radial and tangential directions succeeds (step S57), and the position adjustment of permanent magnet 125 and iron core 154 in radial and tangential directions DR2 and DR4 of magneto-optical recording medium 10 ends.

Subsequent to the ending of the position adjustment of permanent magnet 125 and iron core 154 in radial and tangential directions DR2 and DR4 of magneto-optical recording medium 10, the position adjustment of permanent magnet 125 in normal direction DR3 of magneto-optical recording medium 10 is performed in accordance with the flowchart of FIG. 17.

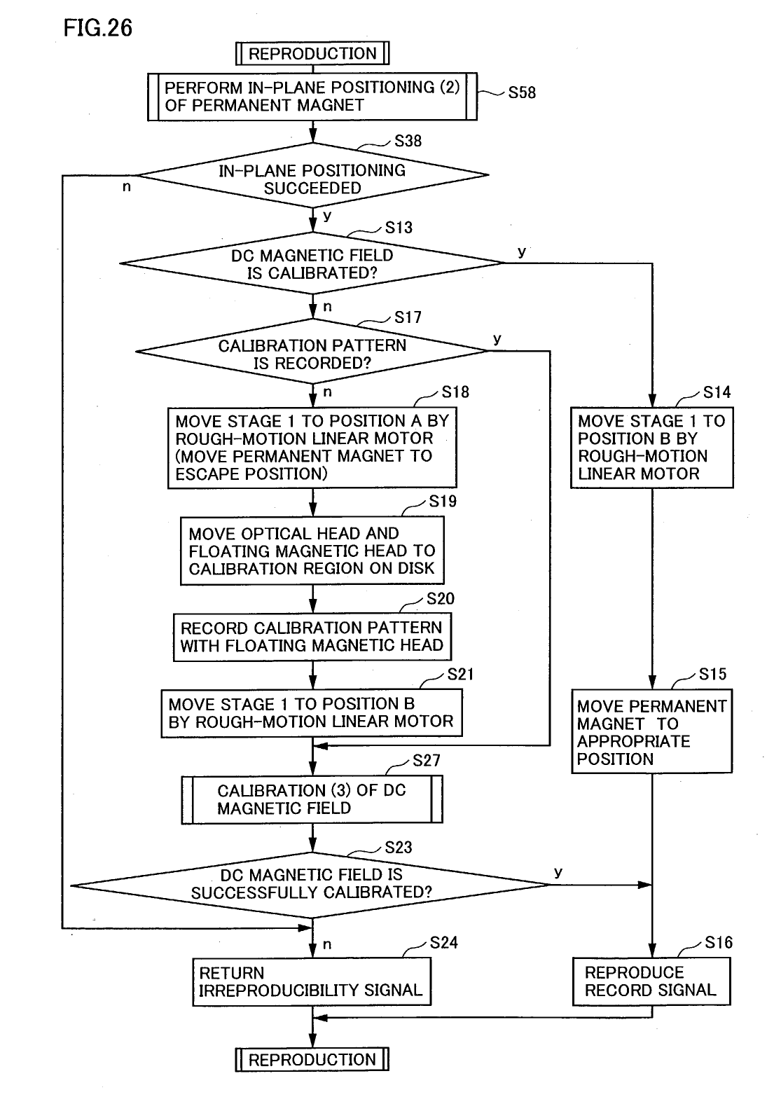

Referring to FIG. 26, description will now be given on the operation of reproducing the signal from magneto-optical recording medium 10. The flow in FIG. 26 is the same as that in FIG. 23 except for that step S37 is replaced with a step S58. In step S58, the operation is performed to adjust the position of permanent magnet 125 and iron core 154 in radial and tangential directions DR2 and DR4, as already illustrated with reference to FIG. 25. Thereafter, the same operation as that already described with reference to FIG. 23 is performed, and the signal is reproduced from magneto-optical recording medium 10 by enlarging the domain.

Magneto-optical disk device 400 is formed of the same structure as magneto-optical disk device 300 shown in FIG. 20. Referring to FIGS. 20 and 21, description will now be given on the operation of magneto-optical disk device 400 for adjusting the position of permanent magnet 125 and iron core 154 in radial and tangential directions DR2 and DR4 of magneto-optical recording medium 10. Controller 166 of magnetic field control circuit 16 outputs the drive signal to fine-motion linear motor 150 for holding a distance of 200 μm between iron core 154 and core 110A so that fine-motion linear motor 150 holds the distance of 200 μm between iron core 154 and core 110A. Thereby, controller 166 outputs the drive signal to magnetic head drive circuit 17 in synchronization with external synchronous signal CLK for producing the magnetic field, which changes the magnetic flux emitted from magnetic head 11A to iron core 154 with time. Magnetic head drive circuit 17 drives magnetic head 11A based on the drive signal sent from controller 166. In synchronization with external synchronous signal CLK, controller 166 produces the drive signal based on the table 3 for moving stage 122 in radial direction DR2 of magneto-optical recording medium 10, and sends it to rough-motion linear motor 124. Rough-motion linear motor 124 moves stage 122 in radial direction DR2 based on the drive signal sent from controller 166. Ammeter 19 detects the value of current flowing through coil 111 of magnetic head 11A, and sends the detected current value to magnetic field control circuit 16. Thereby, controller 166 of magnetic field control circuit 16 determines the appropriate position of iron core 154, at which the current value of 20 mA or more is detected, based on the received current value, and sends the drive signal to rough-motion linear motor 124 in synchronization with external synchronous signal CLK for holding iron core 154 in the determined position. Rough-motion linear motor 124 moves stage 122 in radial direction DR2 based on the drive signal sent from controller 166, and holds iron core 154 in the appropriate position.

In synchronization with external synchronous signal CLK, controller 166 produces the drive signal based on the table 5 for moving stage 122 in radial direction DR2 of magneto-optical recording medium 10, and sends it to fine-motion linear motor 172. Fine-motion linear motor 172 moves stage 170 in radial direction DR2 based on the drive signal sent from controller 166. Ammeter 19 detects the value of current flowing through coil 111 of magnetic head 11A, and sends the detected current value to magnetic field control circuit 16. Thereby, controller 166 of magnetic field control circuit 16 determines the optimum position of iron core 154, at which the current value of 36 mA or more is detected, based on the received current value, and sends the drive signal to fine-motion linear motor 172 in synchronization with external synchronous signal CLK for holding iron core 154 in the determined position. Fine-motion linear motor 172 moves stage 170 in radial direction DR2 based on the drive signal sent from controller 166, and holds iron core 154 in the optimum position.

In synchronization with external synchronous signal CLK, controller 166 produces the drive signal based on the table 4 for moving stage 173 in tangential direction DR4 of magneto-optical recording medium 10, and sends it to fine-motion linear motor 175. Fine-motion linear motor 175 moves stage 173 in tangential direction DR4 based on the drive signal sent from controller 166. Ammeter 19 detects the value of current flowing through coil 111 of magnetic head 11A, and sends the detected current value to magnetic field control circuit 16. Thereby, controller 166 of magnetic field control circuit 16 determines the appropriate position of iron core 154, at which the current value of 26 mA or more is detected, based on the received current value, and sends the drive signal to fine-motion linear motor 175 in synchronization with external synchronous signal CLK for holding iron core 154 in the determined position. Fine-motion linear motor 175 moves stage 173 in tangential direction DR4 based on the drive signal sent from controller 166, and holds iron core 154 in the appropriate position.

In synchronization with external synchronous signal CLK, controller 166 produces the drive signal based on the table 5 for moving stage 173 in tangential direction DR4 of magneto-optical recording medium 10, and sends it to fine-motion linear motor 175. Fine-motion linear motor 175 moves stage 173 in tangential direction DR4 based on the drive signal sent from controller 166. Ammeter 19 detects the value of current flowing through coil 111 of magnetic head 11A, and sends the detected current value to magnetic field control circuit 16. Thereby, controller 166 of magnetic field control circuit 16 determines the optimum position of iron core 154, at which the current value of 36 mA or more is detected, based on the received current value, and sends the drive signal to fine-motion linear motor 175 in synchronization with external synchronous signal CLK for holding iron core 154 in the determined position. Fine-motion linear motor 175 moves stage 173 in tangential direction DR4 based on the drive signal sent from controller 166, and holds iron core 154 in the optimum position.

Thereby, magneto-optical disk device 400 ends the operation of adjusting the positions of permanent magnet 125 and iron core 154 in radial and tangential directions DR2 and DR4 of magneto-optical recording medium 10.

Structures and operations other than the above are the same as those of the third embodiment.

According to the fourth embodiment, magneto-optical disk device 400 includes magnetic field control circuit 16, which moves permanent magnet 125 in the in-plane direction of magneto-optical recording medium 10 to cause electromagnetic induction, and adjusts roughly and finely, i.e., in two stages the position of permanent magnet 125 so that the current caused by such electromagnetic induction may have the maximum value. Further, the magnetic field control circuit 16 determines the appropriate intensity, which provides the error rate of reproduced signal RFD not exceeding the predetermined reference value, based on reproduced signal RFD obtained while changing the intensity of DC magnetic field H_{DCF} by moving permanent magnet 125 in normal direction DR3 of magneto-optical recording medium 10. Therefore, the domain-enlarging reproduction with the DC magnetic field can be accurately performed.

[Fifth Embodiment]

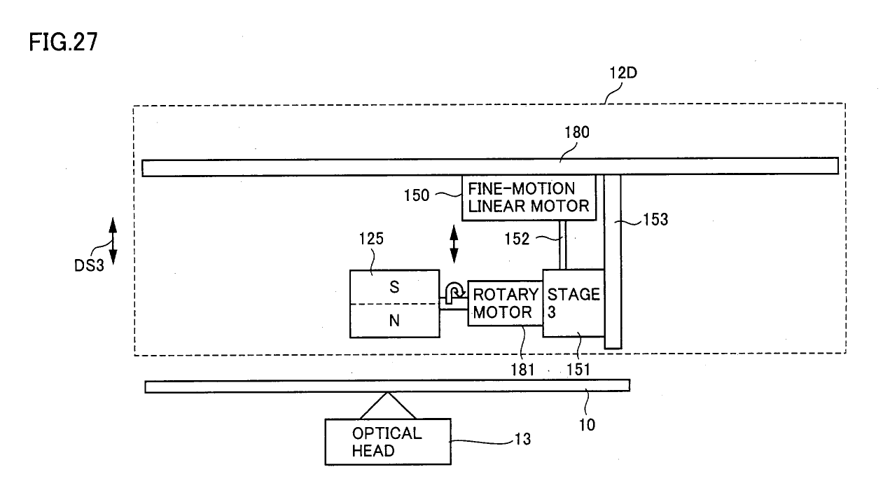

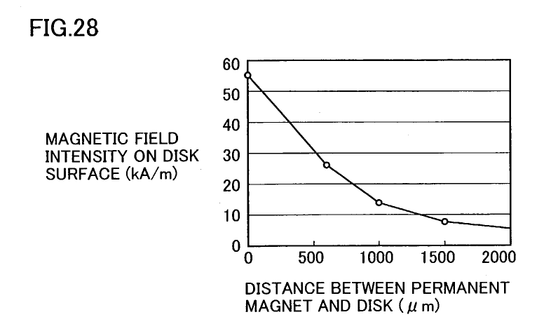

Referring to FIG. 27, a DC magnetic field applying device 12D in a fifth embodiment includes permanent magnet 125, fine-motion linear motor 150, stage 151, arm 152, rail 153, a support rod 180 and a rotary motor 181. DC magnetic field applying device 12D is additionally provided with support rod 180 and rotary motor 181 in addition to permanent magnet 125, fine-motion linear motor 150, stage 151, arm 152 and rail 153, which are the components of DC magnetic field applying device 12A of the second embodiment. DC magnetic field H_{DC} emerging from permanent magnet 125 is directly applied to magneto-optical recording medium 10 without passing through core 110A of magnetic head 11A. In this case, the intensity of DC magnetic field H_{DC} applied to magneto-optical recording medium 10 changes as illustrated in FIG. 28 in accordance with a distance between permanent magnet 125 and magneto-optical recording medium 10.

Fine-motion linear motor 150 is fixed to support rod 180, and rotary motor 181 is fixed to stage 151. DC magnetic field applying device 12D calibrates the intensity of DC magnetic field H_{DC} by changing the distance between permanent magnet 125 and magneto-optical recording medium 10 within a range indicated in the table 2. The manner of calibration is the same as that in the second embodiment.

For erasing the signal recorded on magneto-optical recording medium 10, rotary motor 181 in DC magnetic field applying device 12D rotates permanent magnet 125 to oppose the N-pole of permanent magnet 125 to magneto-optical recording medium 10. For recording the signal on magneto-optical recording medium 10, rotary motor 181 rotates permanent magnet 125 to oppose the S-pole of permanent magnet 125 to magneto-optical recording medium 10.

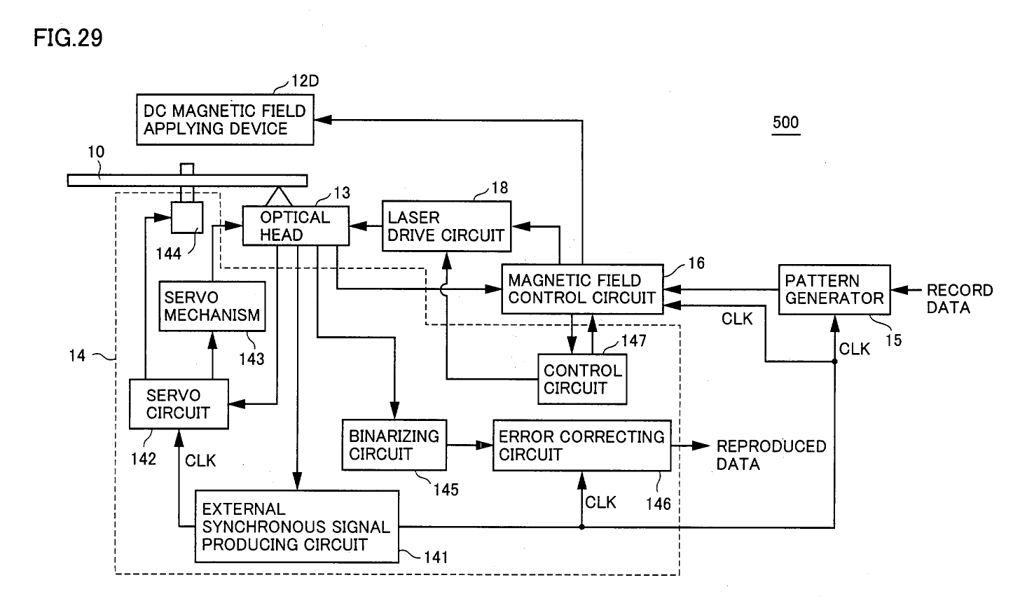

Referring to FIG. 29, a magneto-optical disk device 500 according to the fifth embodiment differs from magneto-optical disk device 100 shown in FIG. 10 in that DC magnetic field applying device 12 is replaced with DC magnetic field applying device 12D, and magnetic head drive circuit 17 is eliminated. Therefore, magneto-optical disk device 500 does not apply an alternating magnetic field to magneto-optical recording medium 10.

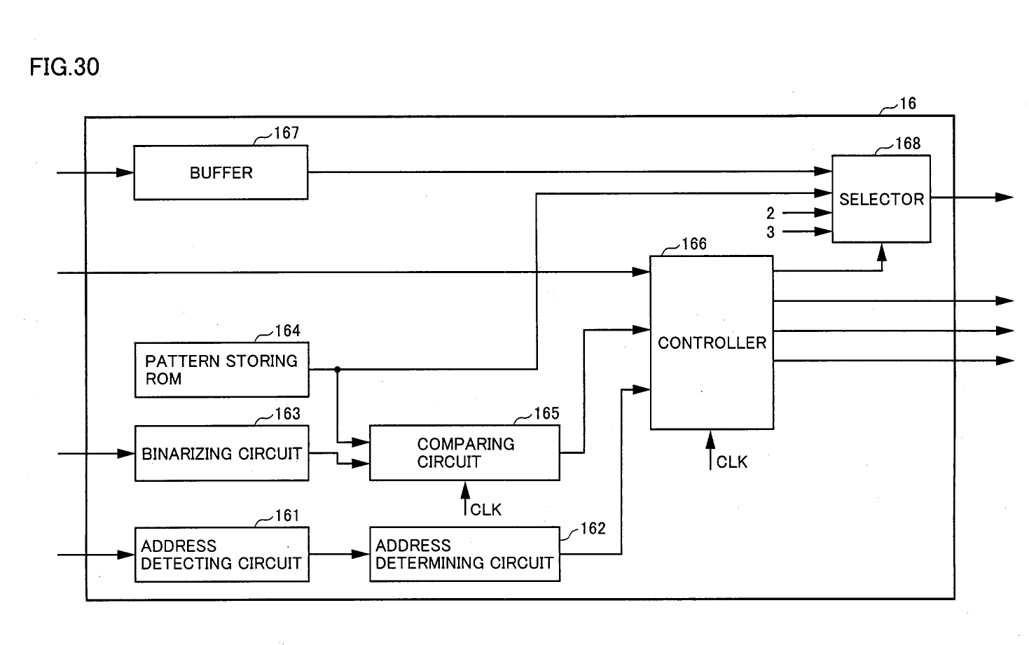

As shown in FIG. 30, magnetic field control circuit 16 of magneto-optical disk device 500 has the same structure as that shown in FIG. 11, but differs therefrom in function. When magneto-optical disk device 500 operates to erase the signal recorded on magneto-optical recording medium 10, controller 166 controls selector 168 to select a signal “2” in synchronization with external synchronous signal CLK. Thereby, selector 168 sends the signal “2” to rotary motor 181 of DC magnetic field applying device 12D. Rotary motor 181 rotates permanent magnet 125 in accordance with the signal “2” to oppose the N-pole to magneto-optical recording medium 10. Thereby, the signal recorded on magneto-optical recording medium 10 is erased.

For recording the signal on magneto-optical recording medium 10, controller 166 controls selector 168 in synchronization with external synchronous signal CLK to select the record signal sent from buffer 167 and a signal “3”, and selector 168 sends the selected signal “3” and the selected record signal to rotary motor 181 of DC magnetic field applying device 12D and laser drive circuit 18, respectively. Thereby, rotary motor 181 rotates permanent magnet 125 to oppose the S-pole of permanent magnet 125 to magneto-optical recording medium 10. Further, laser drive circuit 18 drives the semiconductor laser (not shown) in optical head 13 to turn on/off the laser beam based on the record signal. In this case, the duty of on of laser beam is in a range from 20% to 80%.

Thereby, the record signal is recorded on magneto-optical recording medium 10 in the optical modulation manner.

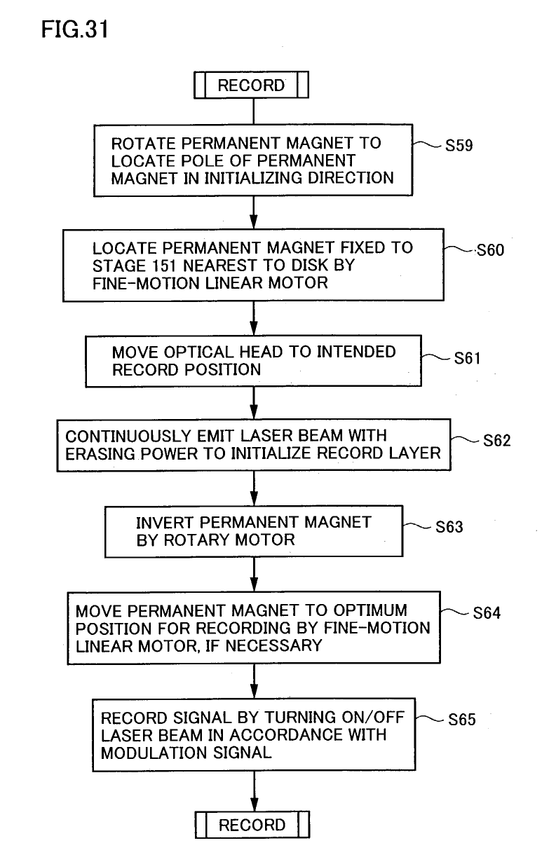

Referring to FIG. 31, description will now be given on the operation of recording the signal by magneto-optical disk device 500. When the recording operation starts, controller 166 in magnetic field control circuit 16 controls selector 168 to select the signal “2” in synchronization with external synchronous signal CLK. Selector 168 selects the signal “2”, and sends it to rotary motor 181 in DC magnetic field applying device 12D. Thereby, rotary motor 181 rotates permanent magnet 125 to oppose the N-pole to magneto-optical recording medium 10 (step S59). Controller 166 sends the drive signal to fine-motion linear motor 150 in synchronization with external synchronous signal CLK for moving permanent magnet 125 toward magneto-optical recording medium 10, and fine-motion linear motor 150 moves permanent magnet 125 toward magneto-optical recording medium 10 based on the drive signal (step S60). Thereafter, optical head 13 is moved to the intended record position (step S61). Laser drive circuit 18 drives the semiconductor laser (not shown) to emit the laser beam having the intensity required for erasing so that the record signal on magneto-optical recording medium 10 is erased (step S62).

Thereby, controller 166 controls selector 168 to select a signal “3” in synchronization with external synchronous signal CLK. Selector 168 selects the signal “3”, and sends it to rotary motor 181. Rotary motor 181 rotates the permanent magnet 125 to oppose the S-pole to magneto-optical recording medium 10 based on the signal “3” (step S63). Fine-motion linear motor 150 moves permanent magnet 125 to the optimum position for recording, if necessary (step S64).

Thereafter, selector 168 selects the record signal sent from buffer 167 under the control of controller 166, and sends it to laser drive circuit 18. Laser drive circuit 18 drives and turns on/off the semiconductor laser (not shown) in optical head 13 based on the record signal. Optical head 13 emits the laser beam, which is modulated with the record signal, to magneto-optical recording medium 10 so that the signal is recorded on magneto-optical recording medium 10. In this manner, magneto-optical disk device 500 ends the recording operation.

In magneto-optical disk device 500, the intensity of DC magnetic field H_{DC} is calibrated in accordance with the same flowchart as that of FIG. 17.

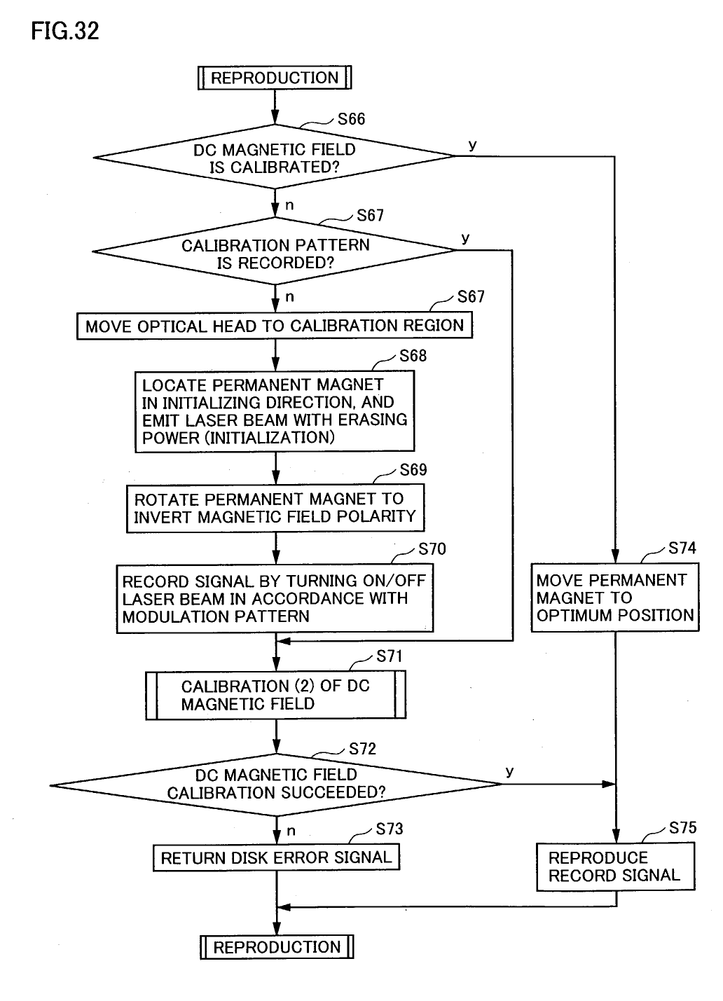

Referring to FIG. 32, description will now be given on the signal reproducing operation of magneto-optical disk device 500. When the reproducing operation starts, it is determined whether DC magnetic field H_{DCF} is already calibrated or not (step S66). If already calibrated, fine-motion linear motor 150 moves stage 151 in normal direction DR3 of magneto-optical recording medium 10 to locate permanent magnet 125 in the optimum position (step S74). Then, magneto-optical recording medium 10 is irradiated with a laser beam of an intensity, which raises the temperature of a portion of reproduction layer 3 to or above the compensation temperature, so that the domain-enlarging reproduction of the signal from magneto-optical recording medium 10 is performed (step S75). In this case, optical head 13 outputs detected magneto-optical signal RFA to binarizing circuit 145, which binarizes magneto-optical signal RFA to output reproduced signal RFD to error correcting circuit 146. Error correcting circuit 146 performs the error correction and demodulation of reproduced signal RFD, and outputs the reproduced data to an external output device (not shown).

If it is determined in a step S66 that DC magnetic field H_{DCF} is not calibrated, it is then determined through optical head 13 whether the predetermined recording pattern “01010101010 . . . ” is recorded on magneto-optical recording medium 10 or not. When it is determined that the predetermined recording pattern “01010101010 . . . ” is not recorded on magneto-optical recording medium 10, controller 166 in magnetic field control circuit 16 controls selector 168 to select the predetermined recording pattern “01010101010 . . . ” from pattern storing ROM 164. Control circuit 147 moves optical head 13 to the calibration region (step S67).

Thereafter, controller 166 controls selector 168 to select the signal “2” in synchronization with external synchronous signal CLK. Selector 168 selects the signal “2”, and outputs it to rotary motor 181 in DC magnetic field applying device 12D. Thereby, rotary motor 181 rotates permanent magnet 125 to oppose the N-pole to magneto-optical recording medium 10. Controller 166 sends the drive signal to fine-motion linear motor 150 in synchronization with external synchronous signal CLK for moving permanent magnet 125 toward magneto-optical recording medium 10, and fine-motion linear motor 150 moves permanent magnet 125 to magneto-optical recording medium 10 in accordance with the drive signal. Thereafter, laser drive circuit 18 drives the semiconductor laser (not shown) to emit the laser beam having the intensity required for the erasing so that the signal recorded on magneto-optical recording medium 10 is erased (step S68).

Thereby, controller 166 controls selector 168 to select the signal “3” in synchronization with external synchronous signal CLK. Selector 168 selects and outputs the signal “3” to rotary motor 181. In accordance with the signal “3”, rotary motor 181 rotates permanent magnet 125 to oppose the S-pole to magneto-optical recording medium 10 (step S69).

Thereafter, selector 168 selects the record signal sent from buffer 167 under the control of controller 166, and sends it to laser drive circuit 18. Laser drive circuit 18 operates based on the record signal to turn on/off the semiconductor laser (not shown) in optical head 13. Optical head 13 emits the laser beam modulated with the record signal to magneto-optical recording medium 10 so that the signal is recorded on magneto-optical recording medium 10 (step S70).

In accordance with the flowchart of FIG. 17, the intensity of DC magnetic field H_{DC} is calibrated (step S71). When the calibration of DC magnetic field H_{DC} succeeds, the operation moves to a step S75, in which DC magnetic field H_{DC} with the calibrated intensity is applied to magneto-optical recording medium 10 to perform the domain-enlarging reproduction.

When the calibration of DC magnetic field H_{DC} failed, control circuit 147 issues a disk error signal (step S73), and magneto-optical disk device 500 ejects magneto-optical recording medium 10. Thereby, the signal reproducing operation of magneto-optical disk device 500 ends.

When the predetermined recording pattern “01010101010 . . . ” is already recorded on magneto-optical recording medium 10 in step S67, the operation moves to step S71.

According to the fifth embodiment, magneto-optical disk device 500 includes magnetic field control circuit 16, which determines the appropriate magnetic field intensity, which provides the error rate of reproduced signal RFD not exceeding the predetermined reference value, based on reproduced signal RFD obtained while changing the intensity of DC magnetic field H_{DC} by moving permanent magnet 125 in normal direction DR3 of magneto-optical recording medium 10. Therefore, the domain-enlarging reproduction with the DC magnetic field can be accurately performed.

Magneto-optical disk device 500 records the signal on magneto-optical recording medium 10 by emitting the laser beam modulated with the record signal. Therefore, even in the magneto-optical disk device recording the signal in the optical modulation manner, the domain-enlarging reproduction can be performed with DC magnetic field H_{DC} having the calibrated intensity.

[Sixth Embodiment]

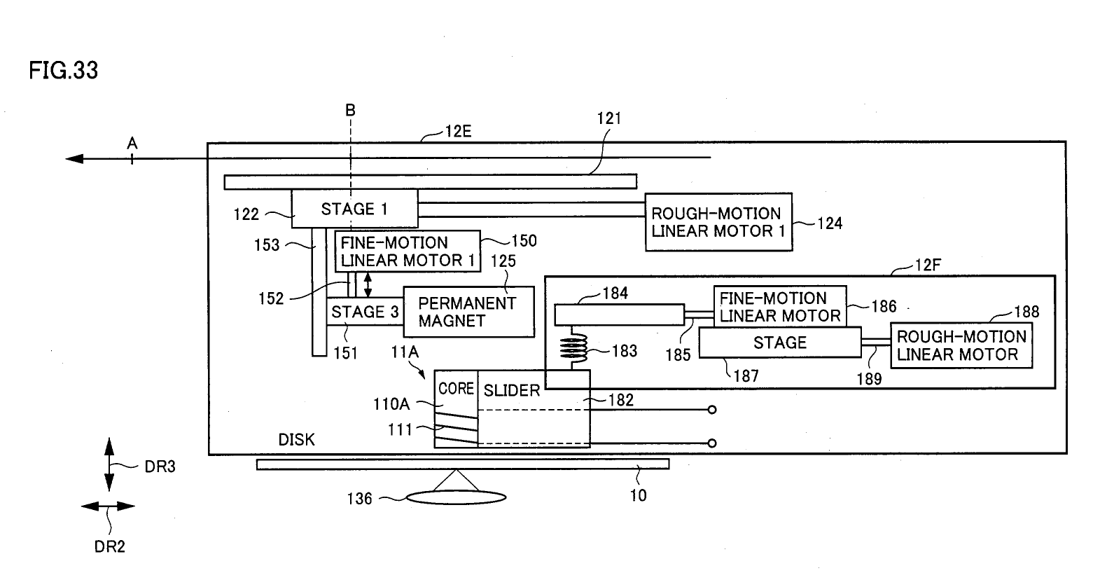

Referring to FIG. 33, a DC magnetic field applying device 12E of a sixth embodiment differs from DC magnetic field applying device 12A shown in FIG. 16 in that a magnetic head position control mechanism 12F is additionally employed. Magnetic head position control mechanism 12F includes a slider 182, a support spring 183, a support member 184, arms 185 and 189, a fine-motion linear motor 186, a stage 187 and a rough-motion linear motor 188. The drive mechanisms in fine-motion and rough-motion linear motors 186 and 188 are the same as those already described with reference to FIG. 7.

Slider 182 is fixed to support member 184 via support spring 183, and support member 184 is connected to fine-motion linear motor 186 via arm 185. Fine-motion linear motor 186 expands or contracts arm 185 to move support member 184 in radial direction DR2 of magneto-optical recording medium 10. Further, fine-motion linear motor 186 is fixed to stage 187, which is connected to rough-motion linear motor 188 via arm 189. Rough-motion linear motor 188 expands or contracts arm 189 to move support member 184 in radial direction DR2 of magneto-optical recording medium 10. Further, slier 182 holds magnetic head 11A, and floats in normal direction DR3 when magneto-optical recording medium 10 rotates.

In magnetic head position control mechanism 12F, therefore, fine-motion and rough-motion linear motors 186 and 188 can contract respective arms 185 and 189 to move slider 182 and magnetic head 11A in the radial direction DR2 of magneto-optical recording medium 10, and permanent magnet 125 directly applies DC magnetic field H_{DC} to magneto-optical recording medium 10. Support spring 183 itself does not shift in radial direction DR2 of magneto-optical recording medium 10. When arm 185 expands or contracts to move support member 184 in radial direction DR2, slider 182 moves in radial direction DR2 together with support member 184.

In the operation of recording the signal on magneto-optical recording medium 10, rough-motion linear motor 124 in DC magnetic field applying device 12E moves the center of stage 122 from point B to point A for locating permanent magnet 125 in an escape position. For reproducing the signal from magneto-optical recording medium 10, magnetic head position control mechanism 12F locates magnetic head 11A and slider 182 in the escape position so that permanent magnet 125 directly applies DC magnetic field H_{DC} to magneto-optical recording medium 10.

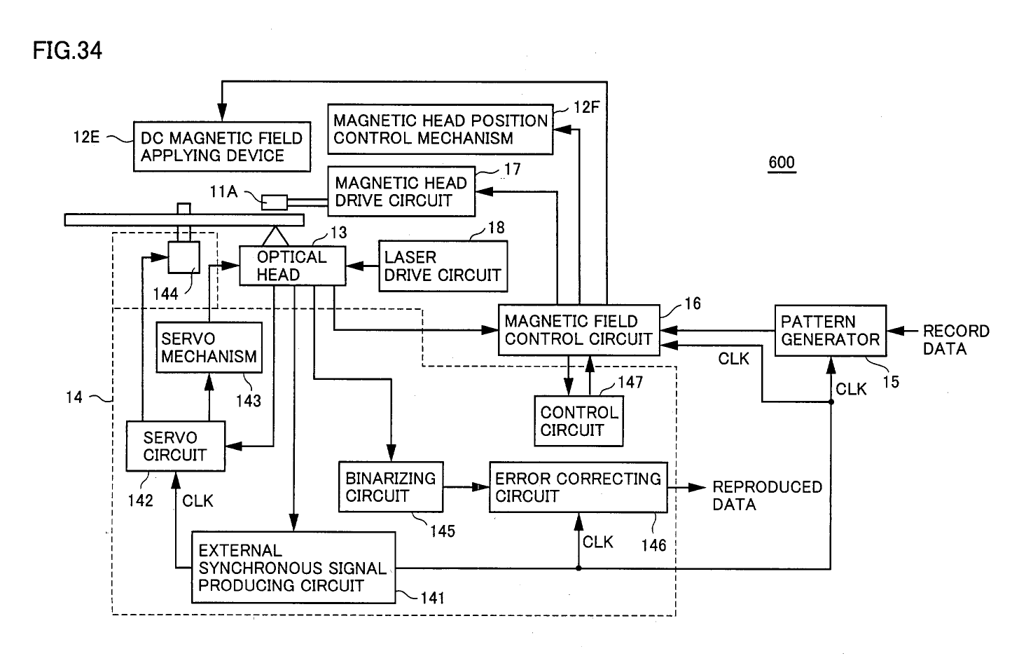

Referring to FIG. 34, a magneto-optical disk device 600 according to the sixth embodiment is the same as magneto-optical disk device 100 in FIG. 10 except for that DC magnetic field applying device 12 in FIG. 10 is replaced with DC magnetic field applying device 12E, and magnetic head position control mechanism 12F is additionally employed.

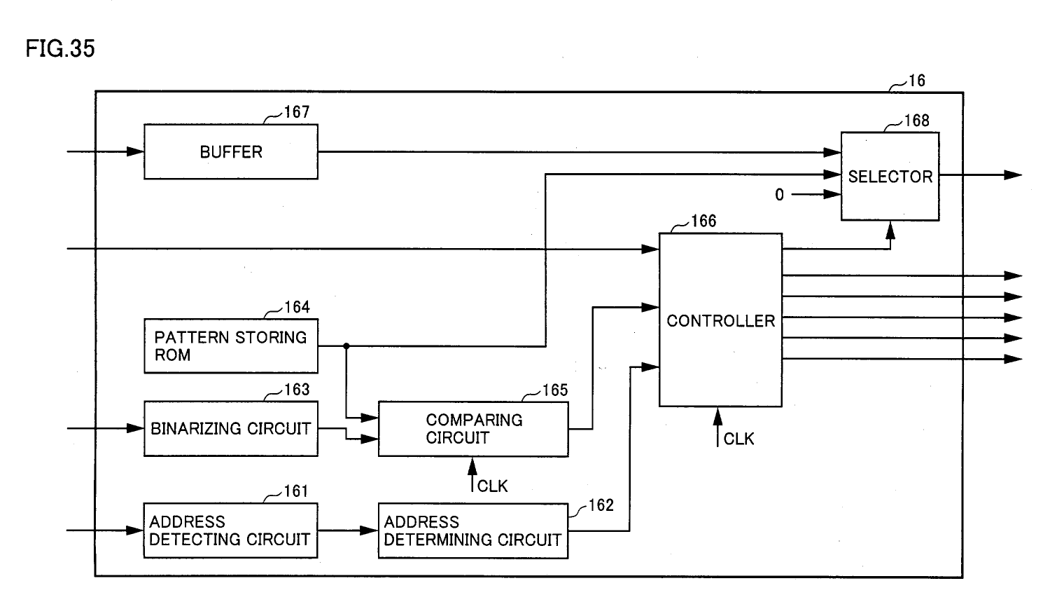

Magnetic field control circuit 16 in magneto-optical disk device 600 shown in FIG. 35 is formed of the same structure as magnetic field control circuit 16 shown in FIG. 11, but differs therefrom in function. For recording the signal on magneto-optical recording medium 10, controller 166 sends the drive signal to rough-motion linear motor 124 in synchronization with external synchronous signal CLK for moving the center of stage 122 from point B to point A. Thereby, rough-motion linear motor 124 moves the center of stage 122 from point B to point A, and moves permanent magnet 125 from the record spot to the escape position. For reproducing the signal from magneto-optical recording medium 10, controller 166 sends the drive signals for contracting arms 185 and 189 to fine-motion and rough-motion linear motors 186 and 189 in synchronization with external synchronous signal CLK, respectively. Thereby, fine-motion and rough-motion linear motors 186 and 189 contract arms 185 and 189, respectively, and magnetic head 11A is moved from the reproduction spot to the escape position.

Structures and operations other than the above are the same as those already described with reference to FIG. 11.

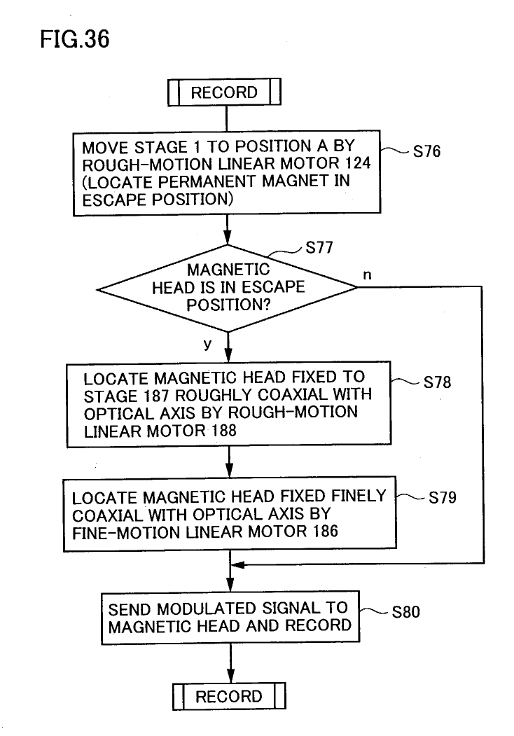

Referring to FIG. 36, the operation of recording the signal by magneto-optical disk device 600 will now be described. When the recording operation starts, controller 166 in magnetic field control circuit 16 sends the drive signal to rough-motion linear motor 124 in synchronization with external synchronous signal CLK for moving the center of stage 122 from point B to point A so that rough-motion linear motor 124 moves the center of stage 122 from point B to point A, and moves permanent magnet 125 from the record spot to the escape position (step S76). It is determined whether magnetic head 11A is in the escape position or not (step S77). If it is in the escape position, controller 166 sends the drive signal to rough-motion linear motor 188 in synchronization with external synchronous signal CLK for roughly matching magnetic head 11A with an optical axis of the laser beam so that magnetic head 11A is roughly located coaxial with the optical axis of the laser beam (step S78). Controller 166 sends the drive signal to fine-motion linear motor 186 in synchronization with external synchronous signal CLK for finely matching magnetic head 11A with the optical axis of the laser beam so that the magnetic head 11A is finely located coaxial with the optical axis of the laser beam (step S79). Thereafter, selector 168 selects the record signal sent from buffer 167 under the control of controller 166, and sends it to magnetic head drive circuit 17. Magnetic head drive circuit 17 drives magnetic head 11A in accordance with the record signal so that magnetic head 11A applies the alternating magnetic field modulated with the record signal to record the signal on magneto-optical recording medium 10 (step S80).

If magnetic head 11A is not in the escape position in step S77, the operation moves to step S80, and the signal recording is effected on magneto-optical recording medium 10.

The intensity of DC magnetic field H_{DC} emerging from permanent magnet 125 is calibrated in accordance with the same flow as that illustrated in FIG. 17 except for that magnetic head position control mechanism 12F moves magnetic head 11A from the reproduction spot to the escape position.

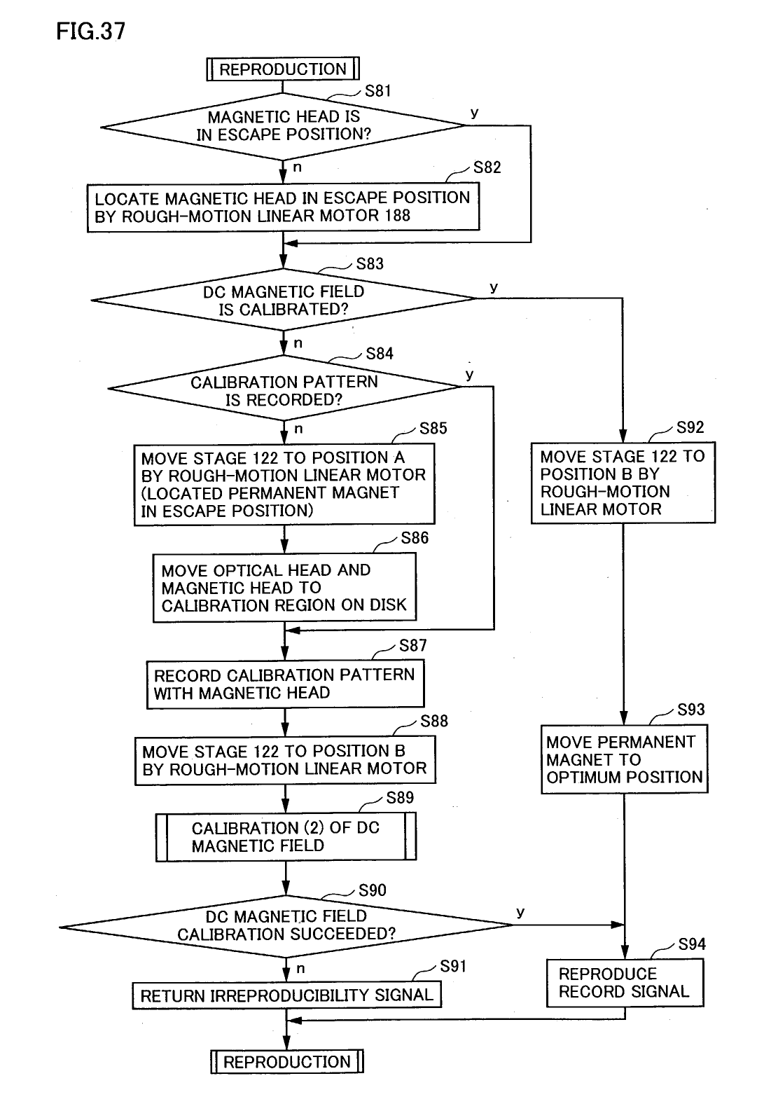

Referring to FIG. 37, description will now be given on the operation of reproducing the signal by magneto-optical disk device 600. When the reproducing operation starts, it is determined whether magnetic head 11A is already moved from the reproduction spot to the escape position or not (step S81). If it is not in the escape position, controller 166 sends the drive signal to rough-motion linear motor 188 in synchronization with external synchronous signal CLK for removing magnetic head 11A from the reproduction spot so that magnetic head 11A is removed from the reproduction spot (step S82).

It is determined whether the intensity of DC magnetic field H_{DC} is calibrated or not (step S83). If not, it is determined whether the calibration pattern, i.e., the predetermined recording pattern “01010101010 . . . ” is recorded on magneto-optical recording medium 10 or not (step S84). If not, controller 166 sends the drive signal to rough-motion linear motor 124 in synchronization with external synchronous signal CLK so that the center of stage 122 is moved from point B to point A, and permanent magnet 125 is removed from the record spot (step S85). Control circuit 147 moves optical head 13 to the record spot, and controller 166 sends the drive signal to fine-motion and rough-motion linear motors 186 and 188 in synchronization with external synchronous signal CLK so that magnetic head 11A is moved to the record spot (step S86). Thereby, selector 168 selects the predetermined recording pattern “01010101010 . . . ” sent from pattern storing ROM 164 under the control of controller 166, and sends it to magnetic head drive circuit 17. In accordance with the predetermined recording pattern “01010101010 . . . ”, magnetic head drive circuit 17 drives magnetic head 11A to apply the alternating magnetic field modulated with the predetermined recording pattern “01010101010 . . . ” to magneto-optical recording medium 10 from magnetic head 11A. Thereby, the predetermined recording pattern “01010101010 . . . ” is recorded on magneto-optical recording medium 10 (step S87).

Thereafter, controller 166 sends the drive signal to rough-motion linear motor 124 in synchronization with external synchronous signal CLK so that the center of stage 122 is moved from point A to point B, and permanent magnet 125 is moved to the reproduction spot (step S88). In this case, controller 166 sends the drive signal to rough-motion linear motor 188 in synchronization with external synchronous signal CLK so that magnetic head 11A is removed from the reproduction spot. In accordance with the flowchart of FIG. 17, the intensity of DC magnetic field H_{DC} is calibrated (step S89).

Thereafter, it is determined whether the calibration of DC magnetic field H_{DC} succeeded or not (step S90). If succeeded, the record signal is reproduced (step S94). If the calibration of DC magnetic field H_{DC} did not succeed, a disk error signal or an irreproducibility signal is issued (step S91), and the reproduction operation ends.

If the calibration pattern is already recorded on magneto-optical recording medium 10 in step S84, the operation moves to step S87.

If the calibration of DC magnetic field H_{DC} is already completed in step S83, controller 166 sends the drive signal to rough-motion linear motor 124 in synchronization with external synchronous signal CLK so that the center of stage 122 is moved from point A to point B, and permanent magnet 125 is moved to the reproduction spot (step S92). Permanent magnet 125 is moved to the optimum position (step S93), and the signal is reproduced from magneto-optical recording medium 10 in the domain-enlarging manner (step S94).

In this manner, the reproduction operation of magneto-optical disk device 600 ends.

Structures and operations other than the above are the same as those of the second embodiment.

According to the sixth embodiment, magneto-optical disk device 600 includes magnetic field control circuit 16 for determining the appropriate intensity, which provides the error rate of reproduced signal RFD not exceeding the reference value, based on the reproduced signal RFD obtained while changing the intensity of DC magnetic field H_{DC} by moving permanent magnet 125 in normal direction DR3 of magneto-optical recording medium 10. Therefore, the domain-enlarging reproduction with the DC magnetic field can be accurately performed.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

According to the invention, the laser beam of the predetermined intensity is emitted to the magneto-optical recording medium, and the DC magnetic field of the predetermined intensity is applied to the magneto-optical recording medium so that the signal can be continuously reproduced from the magneto-optical recording medium in the domain-enlarging manner. Accordingly, the invention is applied to the magneto-optical disk device, which reproduces the signal from the magneto-optical recording medium in the domain-enlarging manner, as well as the signal reproducing method and recording/reproducing method.

1. A magneto-optical disk device comprising:
an optical head (13) irradiating a magneto-optical recording medium (10) including a reproduction layer (3) being rich in rare-earth metal at a room temperature and being rich in transition metal at a compensation temperature or higher with a laser beam of an intensity raising a temperature of a portion of said reproduction layer (3) to or above said compensation temperature, and detecting a reflected beam of said laser beam;
a permanent magnet (125) applying a DC magnetic field in the same direction as that of magnetization of said region rich in the rare-earth metal to said magneto-optical recording medium (10);
moving means (126-129, 150-153, 170-175) changing the intensity of the DC magnetic field applied to said magneto-optical recording medium (10) by changing a density of magnetic flux emerging from said permanent magnet (125) and reaching said magneto-optical recording medium (10); and
a magnetic field control circuit (16) changing the intensity of said DC magnetic field, thereby detecting an error rate based on a reproduced signal of a predetermined recording pattern detected by said optical head (13), and determining an appropriate intensity of said DC magnetic field keeping said error rate within a predetermined range.

2. The magneto-optical disk device according to claim 1, further comprising:
a magnetic head (11, 11A) opposed to said magneto-optical recording medium (10), and including a core (110, 110A) and a coil (111) wound around said core (110, 110A), wherein
said permanent magnet (125) applies said DC magnetic field through said core (110, 110A).

3. The magneto-optical disk device according to claim 2, further comprising:
a magnetic element (130) having an incoming surface (132) neighboring to an outgoing surface (131) for said DC magnetic field of said permanent magnet (125), and an outgoing surface (133) emitting said DC magnetic field incident from said incoming surface (132) to said core (110), wherein
said moving means (126-129) changes a distance between said outgoing surface (133) and said core (110) by moving said magnetic element (130) in an in-plane direction of said magneto-optical recording medium (10).

4. The magneto-optical disk device according to claim 2, wherein
said moving means (150-153) moves said permanent magnet (125) in the direction of the normal to said magneto-optical recording medium (10).

5. The magneto-optical disk device according to claim 2, further comprising:
a magnetic element (154) having an incoming surface neighboring to an outgoing surface for said DC magnetic field of said permanent magnet (125), and an outgoing surface for emitting said DC magnetic field incident through said incoming surface to said core (110A),
a coil (155) wound around said magnetic element (154), and
an ammeter (19) detecting a current flowing through said coil (155) of said magnetic element (154) when said magnetic element (154) receives the magnetic field providing a variable magnetic flux density from said magnetic head (11A), wherein
said moving means (150-153, 170-175) includes:
a first moving mechanism (170-175) moving said permanent magnet (125), said magnetic element (154) and the coil (155) wound around said magnetic element (154) in the in-plane direction of said magneto-optical recording medium (10), and
a second moving mechanism (150-153) moving said permanent magnet (125), said magnetic element (154) and the coil (155) wound around said magnetic element (154) in the direction of the normal to said magneto-optical recording medium (10) to change a distance between said outgoing surface and the core (110A) of said magnetic head (11A); and
said magnetic field control circuit (16) determines an appropriate position of said permanent magnet (125), said magnetic element (154) and the coil (155) wound around said magnetic element (154) in said in-plane direction of said magneto-optical recording medium (10) based on a current value detected by said ammeter (18) while moving said permanent magnet (125), said magnetic element (154) and the coil (155) wound around said magnetic element (154) in said in-plane direction.

6. The magneto-optical disk device according to claim 5, wherein
said first moving mechanism (170-175) moves said permanent magnet (125), said magnetic element (154) and the coil (155) wound around said magnetic element (154) in radial and tangential directions of said magneto-optical recording medium (10), and
said magnetic field control circuit (16) determines the appropriate position of said permanent magnet (125), said magnetic element (154) and the coil (155) wound around said magnetic element (154) in said radial and tangential directions based on the current value detected by said ammeter (19).

7. The magneto-optical disk device according to claim 3, further comprising:
a magnetic head drive circuit (17) driving said magnetic head (11, 11A), and
escape means locating said permanent magnet (125) in an escape position, wherein
in the signal reproduction,
said magnetic head drive circuit (17) stops the driving of said magnetic head (11, 11A);
in the signal recording,
said magnetic head drive circuit (17) drives said magnetic head (11, 11A) to apply an alternating magnetic field modulated with said predetermined recording pattern to said magneto-optical recording medium (10); and
said escape means (121, 123, 124) locates said permanent magnet (125) in the position providing substantially equal two peak intensities in said alternating magnetic field.

8. The magneto-optical disk device according to claim 1, wherein
said moving means (150-153) moves said permanent magnet (125) in the direction of the normal to said magneto-optical recording medium (10).

9. The magneto-optical disk device according to claim 8, further comprising:
rotating means (181) rotating said permanent magnet (125) to change the polarity of said DC magnetic field, and
a laser drive circuit (18) for driving semiconductor laser included in said optical head (13), wherein
in the signal erasing,
said rotating means (181) rotates said permanent magnet (125) to apply the DC magnetic field in a first direction to said magneto-optical recording medium (10);
in the signal recording,
said rotating means (181) rotates said permanent magnet (125) to apply the DC magnetic field in a second direction opposite to said first direction to said magneto-optical recording medium (10); and
said laser drive circuit (18) drives said semiconductor laser based on said predetermined recording pattern.

10. The magneto-optical disk device according to claim 1, further comprising:
a magnetic head drive circuit (17) driving said magnetic head (11A),
first escape means (12F) locating said magnetic head (11A) in an escape position, and
second escape means (121, 123 and 124) locating said permanent magnet (125) in an escape position, wherein
in the signal reproduction,
said first escape means (12F) locates said magnetic head (11A) in a position for applying the magnetic flux emerging from said permanent magnet (125) directly to said magneto-optical recording medium (10);
in the signal recording,
said magnetic head drive circuit (17) drives said magnetic head (11A) to apply an alternating magnetic field modulated with said predetermined recording pattern to said magneto-optical recording medium (10); and
said second escape means (121, 123, 124) locates said permanent magnet (125) in a position providing substantially equal two peak intensities in said alternating magnetic field.

11. The magneto-optical disk device according to any one of the preceding claims 1 to 10, wherein
said magnetic field control circuit (16) includes:
a binarizing circuit (163) binarizing said reproduced signal,
a ROM (164) storing said predetermined recording pattern,
a comparing circuit (165) comparing the reproduced signal sent from said binarizing circuit (163) with the predetermined recording pattern read from said ROM (164) to detect an error rate, and
a control circuit (166) determining the appropriate intensity of said DC magnetic field based on said error rate.

12. A reproduction method of reproducing a signal by applying a DC magnetic field to a magneto-optical recording medium (10) comprising:
a first step of irradiating said magneto-optical recording medium (10) with a laser beam of an intensity raising a temperature of a portion of a reproduction layer (3) of said magneto-optical recording medium (10) to or above a compensation temperature;
a second step of detecting the reproduced signal of the predetermined recording pattern by changing the intensity of said DC magnetic field, and
a third step of detecting an error rate based on said reproduced signal and determining the appropriate intensity of said DC magnetic field to keep said error rate within a predetermined range.

13. A record and reproduction method of reproducing a signal by applying a DC magnetic field to a magneto-optical recording medium (10) and recording a signal by applying an alternating magnetic field to said magneto-optical recording medium (10), comprising:
a first step of recording the signal by irradiating said magneto-optical recording medium (10) with a laser beam, and applying an alternating magnetic field modulated with a predetermined recording pattern to said magneto-optical recording medium (10);
a second step of irradiating said magneto-optical recording medium (10) with a laser beam of an intensity raising a temperature of a portion of a reproduction layer (3) of said magneto-optical recording medium (10) to or above a compensation temperature;
a third step of detecting a reproduced signal of the predetermined recording pattern by changing the intensity of said DC magnetic field; and
a fourth step of detecting an error rate based on said reproduced signal and determining the appropriate intensity of said DC magnetic field to keep said error rate within a predetermined range.

14. A record and reproduction method in a magneto-optical disk device (100, 200, 300, 400, 500, 600) for reproducing a signal by applying a DC magnetic field to a magneto-optical recording medium (10) and recording a signal by applying an alternating magnetic field to said magneto-optical recording medium (10),
said magneto-optical disk device (100, 200, 300, 400, 500, 600) including:
a permanent magnet (125) producing said DC magnetic field, and
a magnetic head (11, 11A) producing said alternating magnetic field,
said method comprising:
a first step of recording the signal by irradiating said magneto-optical recording medium (10) with a laser beam, and applying the alternating magnetic field modulated with a predetermined recording pattern to said magneto-optical recording medium (10);
a second step of irradiating said magneto-optical recording medium (10) with a laser beam of an intensity raising a temperature of a portion of a reproduction layer of said magneto-optical recording medium (10) to or above a compensation temperature;
a third step of detecting a reproduced signal of the predetermined recording pattern by changing the intensity of said DC magnetic field; and
a fourth step of detecting an error rate based on said reproduced signal and determining the appropriate intensity of said DC magnetic field to keep said error rate within a predetermined range, wherein
said first step is configured to locate said permanent magnet (125) in an escape position providing substantially equal two peak intensities in said alternating magnetic field emitted from said magnetic head.

15. The record and reproduction method according to claim 14, wherein
said third step is configured to locate said magnetic head (11A) in an escape position for directly applying magnetic flux emerging from said permanent magnet (125) to said magneto-optical recording medium (10).

16. A record and reproduction method of reproducing a signal by applying a DC magnetic field to a magneto-optical recording medium (10), and recording a signal, comprising:
a first step of recording the signal by emitting a laser beam modulated with a predetermined recording pattern, and applying the DC magnetic field;
a second step of irradiating said magneto-optical recording medium (10) with a laser beam of an intensity raising a temperature of a portion of a reproduction layer (3) of said magneto-optical recording medium (10) to or above a compensation temperature;
a third step of detecting a reproduced signal of the predetermined recording pattern by changing the intensity of said DC magnetic field; and
a fourth step of detecting an error rate based on said reproduced signal and determining the appropriate intensity of said DC magnetic field to keep said error rate within a predetermined range.
